(19) United States
(12) Patent Application Publication
(10) Pub. No.: US 2016/0020466 A1
(43) Pub. Date: Jan. 21, 2016

(54) CARBON NANOTUBE-CONTAINING DISPERSION AND THE USE THEREOF IN THE PRODUCTION OF ELECTRODES

(71) Applicant: BAYER MATERIALSCIENCE AG, Leverkusen (DE)

(72) Inventors: Dagmar ULBRICH, Monheim Am Rhein (DE); Werner HOHEISEL, Köln (DE); Joachim RITTER, Leverkusen (DE); Lars KRUEGER, Leverkusen (DE)

(21) Appl. No.: 14/769,700

(22) PCT Filed: Feb. 20, 2014
(86) PCT No.: PCT/EP2014/053274

§ 371 Date: Aug. 21, 2015

(30) Foreign Application Priority Data
Feb. 22, 2013 (DE) 10 2013 101 803.3
Jul. 5, 2013 (DE) 10 2013 213 273.5

(51) Int. Cl. H01M 4/62; H01M 4/525; H01M 4/04; H01M 4/505

(52) U.S. Cl. CPC H01M 4/625; H01M 4/505; H01M 4/525; H01M 4/623; H01M 4/0404; H01M 4/62; H01M 4/0409; H01M 10/0525

(57) ABSTRACT

The invention relates to a dispersion comprising a dispersion medium, a polymeric dispersing agent, and carbon nanotubes dispersed in the dispersion medium. The proportion of carbon nanotubes present in the form of agglomerates with an average agglomerate size of >=1 [mu]m to the total quantity of carbon nanotubes <=10 vol %, and >=70% of the carbon nanotubes which are not present in the agglomerated form have a length of >=200 nm. the invention further relates to a method for producing such a dispersion, to a method for producing an electrode with the dispersion, to an electrode obtained in this manner, and to an electrochemical element containing the electrode.

The present invention relates to a dispersion comprising a dispersion medium, a dispersing aid and carbon nanotubes dispersed in the dispersion medium. It also relates to a slurry comprising the dispersion and an active material which is customary for secondary batteries and is able to either deintercalate or intercalate lithium ions in the positive or negative electrode during the discharging and charging process according to the use, and optionally further additives. It further relates to a positive or negative electrode comprising the dispersion or slurry of the invention. It additionally relates to a process for producing such a dispersion, to a process for producing such a slurry, to a process for producing an electrode comprising the dispersion or slurry, to an electrode obtained therefrom, and to an electrochemical element comprising the electrode.

Carbon nanotubes (CNTs) are known for their exceptional properties. For example, the tensile strength thereof is about 100 times that of steel (e.g. ST52), the thermal conductivity thereof is about as high as that of diamond, the thermal stability thereof extends right up to 2800° C. under reduced pressure, and the electrical conductivity thereof may be several times the conductivity of copper. However, these structure-related characteristics are frequently accessible at the molecular level only when it is possible to homogeneously distribute carbon nanotubes and to establish maximum contact between the tubes and the medium, i.e. to make them compatible with the medium and hence dispersible in a stable manner.

With regard to electrical conductivity, it is additionally necessary to form a network of tubes in which they are ideally in contact with one another or have adequate proximity to one another only at the ends. At the same time, the carbon nanotubes should have maximum individualization, i.e. be free of agglomerates, and have no alignment. In this case, the carbon nanotubes may be present in a concentration at which such a network is just able to form, which is reflected by the abrupt rise in electrical conductivity as a function of the concentration of carbon nanotubes (percolation limit).

The addition of CNTs as conductive additive to the electrode material for lithium ion batteries and accumulators is of particular interest here. For this purpose, the CNTs should be dispersed in a preferred dispersion medium using a minimum amount of dispersing aid. Moreover, for applications of industrial relevance, a maximum concentration of the CNTs in the dispersion should be assured, which is in the region of well above 1% by weight and preferably above 3% by weight, more preferably above 4% by weight. It has been found that important factors for the performance of such an electrode are not just the quality of the dispersion in relation to the intrinsic morphological properties of the CNTs, for example length, aspect ratio, surface area or defect density, but also the dispersion level or agglomerate content. The latter ultimately depends on the ability of the CNTs to form a homogeneous network around the individual particles of the active material. Moreover, the type and amount of dispersing aid have an effect on the electrical properties, especially on the impedance, of the CMT network and hence also on the electrode overall.

A high-performance electrode is notable for high power and energy density, and also for a long lifetime or cyclability. High power densities in a battery are achieved especially through a high conductivity of the electrode, for which good wetting of the active material is essential. Overall, the individual components of the electrochemical impedance should be at a minimum, which includes minimum contact resistances between well-dispersed CNTs and between these and the electrode output. For this reason, sufficient stabilization should also be achieved with a minimum amount of electrically insulating dispersing aid in the dispersion, but this should also have a sufficiently long shelf life of at least several months.

In the prior art, US 2007/224106 A1 for example, is concerned with CNT dispersions. In this case, the function of a nonionic surfactant for the dispersion of CNTs is described. According to this patent application, it was found that a mixture of an amide-based organic solvent and a polyvinylpyrrolidone or else an amide-based organic solvent, a nonionic surfactant and a polyvinylpyrrolidone can efficiently disperse CNTs. An ultrasound treatment is described as necessary for dispersion of the CNTs. The ultrasound treatment can be conducted during the step of dispersing the CNTs in the nonionic surfactant and/or the amide-based polar organic solvent. Alternatively, a mixture of the nonionic surfactant and/or the amide-based polar organic solvent and polyvinylpyrrolidone can be prepared and the ultrasound treatment is conducted during the dispersion of the CNTs therein.

Disadvantages of the process described in US 2007/224106 A1 are that an ultrasound-based dispersion operation which lasts for many minutes or hours can be employed as an industrial process only with high cost and inconvenience, if at all, and that this process, as known to those skilled in the art, is employable only in the case of dispersions having low concentrations and low viscosities. Furthermore, ultrasound treatments of CNTs often result in fractures of the nanotubes, and so fewer of the desired CNTs having a high ratio of length to diameter are present.

DE 10 2005 043 054 A1 (WO 2007/028369 A1) relates to a dispersion consisting of a dispersing liquid and at least one solid distributed in the dispersing liquid, wherein the dispersing liquid has an aqueous and/or nonaqueous basis, the at least one solid is formed from graphite and/or from porous carbon and/or from carbon nanomaterial and/or from coke, and the at least one solid is distributed homogeneously and stably in the dispersing liquid. In example 3 of this patent application, 10 g of carbon nanotubes (CNTMWs) are dispersed in 500 mL of 2-propanol without additive addition. The carbon nanotubes had a diameter of 10-20 nm and lengths of 1-10 μm, and the specific BET surface area thereof was 200 m²/g. The preliminary dispersion having a viscosity of 600 mPa s was subjected to a shear rate of 2 500 000/sec at a pressure of 1000 bar. As an in-house repetition of this experiment showed, however, the particles obtained here are still too large.

One example of CNT-containing electrodes is the patent application c. It is concerned with an electrode for a secondary battery based on a nonaqueous electrolyte. The electrode comprises an active material, a binder, CNTs and a non-fibrous conductive carbon material, with a PVP-based polymer present in a proportion of 5 to 25 parts by weight of 100 parts by weight of CNTs.

It is an object of the present invention to at least partially eliminate the disadvantages in the prior art. A particular object is that of providing CNT dispersions which can be used in the production of improved electrodes for batteries and accumulators or supercapacitors. A process for producing such dispersions is likewise an object of the invention.

This object is achieved in accordance with the invention by a dispersion comprising a dispersion medium, a preferably polymeric dispersing aid and carbon nanotubes dispersed in the dispersion medium, wherein the proportion of carbon nanotubes present in agglomerates having an average agglomerate size of ≧1 μm in the total amount of carbon nanotubes is ≦40% by volume, and ≧70% by weight of the carbon nanotubes present in nonagglomerated form have a length of ≧200 nm.

The dispersions of the invention can be used for production of electrodes in a lithium ion battery having elevated power density and prolonged lifetime. Downstream products are a slurry for application to an electrode output and the provision of the electrode for a lithium ion battery. In other words, the dispersion can serve as the basis for production of a slurry which, when applied to a suitable output conductor (preferably aluminum for the positive electrode and copper for the negative electrode), drying and calendering, serves for production of a battery electrode or accumulator electrode.

Preferably, the proportion of carbon nanotubes present in agglomerates having an average agglomerate size of ≧1 μm in the total amount of carbon nanotubes is ≦20% by volume, more preferably ≦10% by volume. The unit “% by volume” relates hereinafter to the volume-based cumulative distribution Q3 known to those skilled in the art, which describes an upper or lower range or an interval in the corresponding distribution. The percentages by volume described here relate to values which are determined with a laser diffraction instrument for measurement of a particle size distribution.

It is additionally preferable that ≧80% by weight, even more preferably ≧90% by weight, of the carbon nanotubes in nonagglomerated form have a length of ≧200 nm. This can be determined by means of transmission electron microscopy on a corresponding dispersion sample. It will be appreciated that a few contacts of the individualized CNTs with one another does not mean that the CNTs have to be characterized as agglomerated.

Carbon nanotubes (CNTs) in the context of the invention are all single-wall or multiwall carbon nanotubes of the cylinder type (for example in Iijima patent U.S. Pat. No. 5,747,161; Tennant WO 86/03455), scroll type, multiscroll type, cup-stacked type composed of conical cups closed at one end or open at both ends (for example in Geus patent EP198,558 and Endo U.S. Pat. No. 7,018,601B2), or having onion-like structure. Preference is given to using multiwall carbon nanotubes of the cylinder type, scroll type, multiscroll type and cup-stacked type, or mixtures thereof. It is favorable when the carbon nanotubes have a ratio of length to external diameter of ≧5, preferably ≧100.

In contrast to the already mentioned known carbon nanotubes of the scroll type having only one continuous or interrupted graphene layer, there also exist carbon nanotube structures consisting of a plurality of graphene layers which have been combined to form a stack and rolled up. These are referred to as the multiscroll type. These carbon nanotubes are described in DE 10 2007 044031 A1, which is referenced in full. This structure compares to the carbon nanotubes of the simple scroll type in a comparable manner to that in which the structure of multiwall cylindrical carbon nanotubes (cylindrical MWNTs) compares to the structure of single-wall cylindrical carbon nanotubes (cylindrical SWNTs).

In contrast to the case of onion-type structures, the individual graphene or graphite layers in these carbon nanotubes, viewed in cross section, appear to pass uninterrupted from the center of the carbon nanotubes up to the outer edge.

Preferably, but not exclusively, the viscosity of the dispersions of the invention is adjusted by variation of the CNT concentration and not via the dispersing aid. Likewise preferably, but not exclusively, the viscosity should be within a window at a shear rate of Its between about 0.01 Pa·s and about 1000 Pa·s, preferably between 0.1 Pa·s and about 500 Pa·s and more preferably between 1 Pa·s and about 200 Pa·s, in order to assure good processibility of the dispersion and the slurries derived therefrom to give electrode layers having suitable layer thicknesses. The viscosity can be measured with a suitable rotary viscometer (for example from Anton Paar, MCR series).

Embodiments and further aspect of the invention are described hereinafter. They can be combined with one another as desired, unless the opposite is clear from the context.

In one embodiment of the dispersion of the invention, the dispersion medium is selected from the group of water, acetone, nitriles, alcohols, dimethylformamide (DMF), N-methyl-2-pyrrotidone (NMP), pyrrolidone derivatives, butyl acetate, methoxypropyl acetate, alkylbenzenes, cyclohexane derivatives and mixtures thereof. Preference is given to using water, dimethylformamide (DMF), N-methyl-2-pyrrolidone (NMP) and/or pyrrolidone derivatives.

In a further embodiment of the dispersion of the invention, the dispersing aid is selected from the group of poly(vinylpyrrolidone) (PVP), polyvinylpyridines (e.g. poly(4-vinylpyridine) or poly(2-vinylpyridine)), polystyrene (PS), poly(4-vinylpyridine-co-styrene), poly(styrenesulfonate) (PSS), lignosulfonic acid, lignosulfonate, poly(phenylacetylene) (PPA), poly(meta-phenylenevinylene) (PmPV), polypyrrole (PPy), poly(p-phenylenebenzobisoxazole) (PBO), naturally occurring polymers, anionic aliphatic surfactants, poly(vinyl alcohol) (PVA), polyoxyethylene surfactants, poly(vinylidene fluoride) (PVdF), cellulose derivatives (generally and especially those in which the hydrogen atom in some hydroxyl groups in the glucose units has been replaced by methyl or ethyl or higher groups, for example methyl cellulose (MC) or ethyl cellulose (EC), cellulose derivatives in which the hydrogen atom in some hydroxyl groups in the glucose units has been replaced by hydroxymethyl, hydroxyethyl, hydroxypropyl or higher groups, for example hydroxymethyl cellulose (HMC), hydroxyethyl cellulose (HEC) or hydroxypropyl cellulose (HPC), cellulose derivatives in which the hydrogen atom in some hydroxyl groups in the glucose units has been replaced by carboxymethyl, carboxyethyl or higher groups, for example carboxymethyl cellulose (CMC) or carboxyethyl cellulose (CEC), cellulose derivatives in which the hydrogen atom in some hydroxyl groups in the glucose units has been replaced partly by alkyl groups and partly by hydroxyalkyl groups, for example hydroxyethyl methyl cellulose (HEMC) or hydroxypropyl methyl cellulose (HPMC)), mixtures of different cellulose derivatives, polyacrylic acid (PAA), polyvinyl chloride (PVC), polysaccharides, styrene-butadiene rubber (SBR), polyamides, polyimides, block copolymers (for example acrylic block copolymers, ethylene oxide-propylene oxide copolymers) and mixtures thereof.

Further additives having biocidal action can be added if required. In that case, these do not act as dispersing aids themselves, but contribute to the shelf life of the dispersion if it contains natural substances that colonize bacteria, fungi, yeast or algae, for example celluloses and derivatives thereof or lignosulfonic acid, as dispersing aid.

Many dispersing aids are ionic in nature and contain sodium as counterions. In a further embodiment, the dispersing aid comprises lithium ions. These lithium ions as counterions can, for example, either be introduced directly in the course of preparation or be exchanged later with the aid of ion exchangers. Examples include carboxymethyl cellulose (CMC) or polyacrylic acid (PAA). The advantage of this course of action lies in presaturation of the material, such that the loss of capacity that often occurs in the first charge and discharge cycle in later use in electrodes can be ruled out or at least crucially reduced.

Explicitly preferred, incidentally, is the combination of N-methyl-2-pyrrolidone (NMP) as dispersion medium together with PVP, EC, MC, polyvinylpyridine, poly(4-vinylpyridine-co-styrene), polystyrene (PS) or mixtures thereof as dispersing aid. Also explicitly preferred is the combination of water as dispersion medium and PVP or cellulose derivatives, for example with CMC (or SBR rather than PVP) or mixtures of the two as dispersing aids.

Preference is further given to low molecular weight types of these dispersing aids, PVP having a number-average molecular weight of less than 200 000 g/mol, more preferably between 10 000 g/mol and 100 000 g/mol, most preferably between 25 000 g/mol and 75 000 g/mol. Preference is likewise given to types that bring about a low viscosity, in order thus to be able to produce a higher CNT concentration. In the case of use of CMC as dispersing aid, moreover, it is preferable that substitution levels are not too high, and these should be between 0.5 and 1.5, preferably between 0.6 and 1.1, in order to obtain good stabilization of the dispersion by virtue of good affinity for polar media such as water on the one hand, and in order to assure stable non-covalent attachment to the CNT through sufficiently hydrophobic components in the CMC molecule on the other hand.

In a further embodiment of the dispersion of the invention, the carbon nanotubes present in non-agglomerated form are multiwall carbon nanotubes having an average external diameter of ≧3 nm to ≦100 nm, preferably ≧5 nm to ≦50 um and a ratio of length to diameter of ≧5, preferably ≦100.

In a further embodiment of the dispersion of the invention, the carbon nanotubes are present in a proportion of ≧1% by weight and ≦25% by weight, preferably ≧3% by weight and ≦15% by weight, based on the total weight of the dispersion.

In a further embodiment of the dispersion of the invention, the ratio of the concentration of the dispersing aid in the dispersion medium and the concentration of the carbon nanotubes in the dispersion medium is within a range from ≧0.01:1 to ≦10:1, preferably ≧0.01:1 to ≦0.9:1, more preferably ≧0.01:1 to ≦0.6:1, most preferably ≧0.02:1 to ≦0.3:1. A minimum proportion of dispersing aids is preferable here in order to minimize any disruptive influence of these auxiliaries in later use.

In a further embodiment of the dispersion of the invention, it further comprises conductive carbon black, graphite and/or graphene. Preferably, the mass ratio of carbon nanotubes and at least one element of these material classes is between 1:10 and 10:1 and more preferably between 1:3 and 3:1. In addition, at least one element from these material classes may also be added as a separate dispersion or as a powder in the preparation of the electrode slurry (see below). The advantage of the addition of such carbonaceous conductive materials has been determined empirically and is probably caused by a better pore structure in the electrode. Incidentally, a cost saving can be achieved thereby.

In a more sophisticated assessment, the specific surface area of the CNTs can be expressed in relation to the relative proportion of dispersing aids. In this context, the relative proportion of dispersing aids to CNTs should rise constantly with rising specific surface area (according to Brunauer, Emmett, Teller: BET). For instance, for CNTs having a specific (BET) surface area of about 130 m²/g (for example Baytubes C70P, Bayer AG) in NMP dispersion medium with PVP as dispersing aid (for example PVP K30, Luvitec, BASF AG), the following holds for the concentration ratios of PVP and CNTs: 0.01:1≦(C_{PVP}:C_{CNT})≦0.5:1, preferably 0.02:1≦(C_{PVP}:C_{CNT})≦0.25:1, more preferably 0.04:1≦(C_{PVP}:C_{CNT})≦0.2:1, most preferably 0.06:1≦(C_{PVP}:C_{CNT})≦0.18:1. C_{PVP} and C_{CNT} are the respective concentrations (% by weight) of PVP and CNT in the dispersion medium. For CNTs having a specific (BET) surface area of about 210 m²/g (for example Baytubes C150P, Bayer AG) in NMP dispersion medium, the following holds for the concentration ratios of PVP (for example PVP K30, Luvitec, BASF AG) and CNTs: 0.02:1≦(C_{PVP}:C_{CNT})≦0.6:1, preferably 0.06:1≦(C_{PVP}:C_{CNT})≦0.4:1, more preferably 0.1:1≦(C_{PVP}:C_{CNT})≦0.3:1, most preferably 0.15:1≦(C_{PVP}:C_{CNT})≦0.25:1

In the case of use of CNTs having a specific (BET) surface area of about 130 m²/g (for example Baytubes C70P, Bayer AG) in NMP dispersion medium with ethyl cellulose as dispersing aid (for example ETHOCELL 100, Dow Wolff Cellulosics), similar concentration ratios of ethyl cellulose (EC) and CNTs hold: 0.01:1≦(C_{EC}:C_{CNT})≦0.5:1, preferably 0.02:1≦(C_{EC}:C_{CNT})≦0.25:1, more preferably 0.04:1≦(C_{EC}:C_{CNT})≦0.2:1, C_{PVP} and C_{EC} are the respective concentrations (% by weight) of EC and CNT in the dispersion medium. In the case of use of methyl cellulose, other cellulose derivatives, polystyrene, poly(4-vinylpyridine) or poly(4-vinylpyridine-co-styrene), the concentration ratios that hold with those CNTs having a similar specific (BET) surface area to Baytubes C70P (Bayer AG) are analogous. In the case of use of CNTs having a higher specific (BET) surface area, for example Baytubes C150P (Bayer AG) having a specific (BET) surface area of about 210 m²/g or Nanocyl 7000 having a specific (BET) surface area of about 250-300 m²/g, it is necessary to use correspondingly higher concentrations of dispersing aids, as already detailed using the example of PVP.

The same concentration ratios also hold when the dispersing medium used is water and the dispersing aid CMC (for example walocel CRT 30G, Dow Chemicals).

A further aspect of the present invention is a process for producing a dispersion of the invention, wherein a precursor dispersion comprising a dispersion medium, a polymeric dispersing aid and carbon nanotubes is dispersed by means of a high-pressure homogenizer.

In the production of the dispersions of the invention, pretreatments of CNTs, which may also consist of commercially available materials (for example Baytubes C70P or C150P, Nanocyl NC7000 from Nanocyl S.A. or AMC from UBE Industries), are optional. According to the moisture content of the CNTs, this may optionally be followed by drying (preferably 60-150° C. for 30-150 min) under air.

This is followed, also optionally, by a preliminary comminution of large CNT agglomerates, in such a way that the morphological structure of the CNTs is not altered apart from a certain degree of shortening (tubular structure is preserved). The d50 (laser diffraction) of the agglomerate size after the preliminary comminution is, for example, <100 μm, preferably <30 μm, more preferably <10 μm.

A preferred process of pretreatment is a dry grinding operation, which can be conducted by means of a knife mill, mortar mill, planetary ball mill or other suitable mills known to the expert. The purpose of this process step is the provision of smaller, compact CNT agglomerates and is employed optionally only in order to prevent any blockages of nozzles, lines or valves, as used in one or more of the subsequent steps. Whether a pretreatment with a mill is necessary depends on the morphology of the CMT agglomerates used and on the effectiveness of the downstream preliminary dispersion operation.

For preliminary dispersion, a mixture of the CNT powder with dispersing aid and dispersion medium having the desired concentration and viscosity is produced. The mixing operation is effected, for example, with a disperser having high shear forces, such as a rotor-stator system, until a homogeneous dispersion with dispersion medium, dispersing aid and CNT agglomerates (having a size (d50, laser diffraction) of <500 μm, preferably <100 μm, more preferably <50 μm) is present. Corresponding apparatuses having a rotor-stator system are supplied, for example, by Fluid Kotthoff GmbH, Germany, or Cavitron GmbH, Germany.

This is followed by dispersion by means of a high-pressure homogenizer. These consist essentially of a high-pressure pump and at least one nozzle for the homogenization. The pressure built up by the high-pressure pump is released in the homogenizing valve, which brings about the dispersion of the CNT agglomerates. High-pressure systems with which dispersions of CNTs can be produced are described in terms of principle, for example, in S. Schultz et al. (High-Pressure Homogenization as a Process for Emulsion Formation, Chem. Eng. Technol. 27, 2004, p. 361-368). A special design of the high-pressure homogenizer is that of the jet disperser. This builds up a high pressure with a pump, which is released through a circular, slot-shaped or differently shaped nozzle. Without restriction of generality, the pump can be operated continuously, but also discontinuously, for example pneumatically or hydraulically via piston operation. The nozzle may be equipped with a single orifice or bore. It is also possible to use nozzles having two else more orifices, which may be arranged opposite one another or in an outer ring with respect to one another (see, for example, DE 19536845). In a preferred embodiment, the nozzles are manufactured from iron-free ceramic materials, for example aluminum oxides also with optional additions of zirconium oxides, yttrium oxides or other oxides commonly used for ceramics, or from other metal carbides or nitrites. The advantage in the case of use of these materials is that contamination of the dispersion with iron is avoided. Jet dispersers are described in general terms, for example, in Chemie Ingenieur Technik, volume 77, issue 3 (p. 258-262).

The basic rule is that the fineness of the dispersion produced depends on the pressure and on the nozzle used. The smaller the nozzle bore or slot width and the higher the pressure, the finer the resultant dispersion will be. Smaller nozzle orifices generally require and enable higher working pressures. However, excessively small nozzle bores can lead to blockages or cause excessive limitations in the usable viscosities, which in turn limits the usable CNT concentrations. An excessively high pressure can also cause lasting damage to the morphological structure of the CNTs, and so an optimum has to be found in the apparatus parameters for every system comprising dispersion medium, CNTs and dispersing aid.

The pressure differential Δp is, for example, Δp>50 bar, preferably Δp>150 bar, more preferably 1500 bar>Δp>250 bar, and most preferably 1200 bar>Δp>500 bar. Smaller bore diameters or slot widths lead in principle to better dispersion outcomes (i.e. higher proportion of individualized CNTs in the dispersion), but with a rising risk that larger agglomerates will block or clog the nozzle(s). Two or more nozzles opposite one another have the advantage that abrasion in the nozzle is minimized, since the dispersing jet is not directed against a solid impact plate and hence entrained impurities in the dispersion are minimized.

The viscosity of the dispersion also limits the choice of bore diameter or slot width in the downward direction. Suitable nozzle diameters thus have to be adjusted in a manner known to those skilled in the art according to the agglomerate size and viscosity of the dispersion.

A further preferred high-pressure homogenizer for production of the dispersion of the invention is notable for a valve having variable width of a slot. In this case, a pump is used to build up a pressure in a volume, the pressure opens up a slot via a movable ram, and the dispersion is decompressed through the slot by virtue of the pressure gradient. The slot width and hence the pressure built up can be adjusted manually, via a mechanical or electrical closed-loop control circuit. The slot width or the pressure built up can alternatively be regulated automatically via the opposing force exerted by the ram, which is adjustable, for example, via a spring. The slot is often an annular slot. The operation is also tolerant to agglomerates in the region of 100 μm. The corresponding process is known and described in EP0810025, and corresponding equipment is sold, for example, by GEA Niro Soavi (Parma, Italy).

A further preferred high-pressure homogenizer for production of the dispersion of the invention works batchwise and compresses the dispersion using a ram in a piston cylinder at >500 bar, preferably >1000 bar. The dispersion is decompressed through a slot, preferably through an annular slot. The process is known, and corresponding equipment is sold, for example, by APV Gaulin Deutschland GmbH, Lübeck, Germany (for example Micron LAB 40).

In one embodiment of the process of the invention, the dispersion by means of the high-pressure homogenizer is conducted more than once. The dispersing operation can thus be repeated until the CNTs have been individualized satisfactorily. The number of repetitions depends on the material used, the CNT concentration, the viscosity and the pressure employed, and may be 30, 60 or even more than 100. In general, the number of runs necessary rises with the viscosity of the dispersion. From the point of view of dispersion quality, an upper limit is advisable from an economic point of view but unnecessary from a technical point of view, since the quality of the dispersion decreases only very gradually as a result of excessively frequent repetition.

A further aspect for the dispersion outcome is not just the total energy which is introduced into the dispersion but also the power density or stress intensity (energy input per unit time and volume of the dispersion) of the CNT agglomerates in the dispersion. This means that, if the pressure differential is below a particular level, fine distribution is possible only with difficulty irrespective of the total energy input. The lower limit in the power density necessary to achieve a good dispersion outcome is product specific and depends on the type of CNTs, the pretreatment thereof, the solvent and the dispersing aids. The total energy needed, based on the amount of CNTs used, to achieve a good dispersion outcome may be about 40 000 kJ/kg when small pressure differentials (about 200 bar) are employed, or even less than 15 000 kJ/kg in the case of high pressure differentials exceeding 800 bar.

From an economic point of view, in general, limitation to about 150 repetitions is advisable. However, a higher number is not prohibitive for the process according to the invention. The repetitions can be effected in the same nozzle with a time delay, in accordance with a cyclic mode of operation. Alternatively, they can be effected at different locations in series-connected nozzles or in a combination of a limited number of spatially offset nozzles with a cyclic mode of operation. A process is also in accordance with the invention when the repetitions are divided into blocks in such a way that the dispersion operations in the individual blocks are effected with different nozzle sizes, nozzle shapes and working pressures. This may be advisable especially when the viscosity of the dispersion changes during the dispersion operation. It is advantageous at first to use larger bore diameters and later, when the viscosity decreases, smaller bore diameters or slot widths. It is advantageous here to use continuously adjustable slot widths, as described, for example, in DE 10 2007 014487 A1.

During the dispersing operation of CNTs, at the transition from larger agglomerates toward individual CNT fibers, there is frequently a temporary increase in viscosity which hinders passage through the nozzles or even makes it impossible, i.e. leads to clogging/blockage. Therefore, in a further embodiment of the process of the invention, a series of predispersed mixtures with rising concentration of CNTs in the dispersion medium and the appropriate amount of dispersing aid are first produced. Thereafter, the predispersed mixtures are fed consecutively, starting from the lowest concentration, to the high-pressure homogenizer. After the addition of the last, most highly concentrated mixture, an overall dispersion is then obtained with a moderate concentration based on the predispersed mixtures.

In a further embodiment, a component dispersion of comparatively low concentration which has already been subjected to a treatment with a high-pressure homogenizer is concentrated by addition of CNT powder which has optionally already been sent to a precomminuting operation, and sent to a new predispersion operation. This mixture is subsequently treated again with the high-pressure homogenizer to obtain a dispersion having an elevated concentration compared to the first dispersion. This operation can be repeated if required until the desired final concentration of the dispersion and total amount has been attained.

In a further embodiment of the process of the invention, the high-pressure homogenizer is a jet disperser and has at least one nozzle having a bore diameter of ≧0.05 to ≦1 mm and a length to diameter ratio of the bore of ≧1 to ≦10, wherein there is a pressure differential of ≧5 bar between the nozzle inlet and nozzle outlet.

In a further embodiment of the process of the invention, the jet disperser has at least one slot having a slot width of ≧0.05 to ≦1 mm and a depth to slot width ratio of the slot of ≧1 to ≦10, wherein there is a pressure differential of ≧5 bar between the nozzle inlet and nozzle outlet.

A preferred jet disperser for production of the dispersion of the invention is described in DE 19536845 A1. The bore diameter or slot width in the nozzle for the present invention is, for example, 0.1 mm to 1 mm, preferably from 0.2 mm to 0.6 mm, Further refinements of the jet disperser are described, for example, in DE 10 2007 014487 A 1 and WO 2006/136292 A1.

The present invention further relates to a composition for production of an electrode, comprising a dispersion of the invention, an electrode material and a polymeric binder, wherein the binder is present in the composition at least partly in dissolved form. Optionally, particulate graphite or conductive carbon black may be added to the composition as conductive material.

The “composition” addressed is also referred to as slurry. The slurry is produced by mixing the dispersion of the invention, a suitable binder which is dissolved or distributed in the dispersion medium, and an active material for intercalation and storage of lithium ions. Preferably, the establishment of a suitable viscosity at maximum solids content is ensured.

For the electrode material, it is possible to use the known material classes. For positive electrodes, it is possible to use lithium-intercalating compounds, for example layered compounds, spinets or olivines.

In a preferred embodiment of the composition, the electrode material is selected from the group of LiNiₓMn_{y}Al_{z}Co_{1-x-y-z}O₂ (0≦x, y, z≦1 and x+y+z≦1), LiNi_{0.33}Mn_{0.33}Co_{0.33}Co_{0.33}O₂, LiCoO₂, LiNi_{0.7}Co_{0.3}O₂, LiNi_{0.8}Co_{0.2}, LiNi_{0.9}Co_{0.1}O₂, LiNiO₂, LiMn₂O₄, LiMn_{1.5}(Co,Fe,Cr)_{0.5}O₄, LiNiₓAl_{y}Co_{1-x-y}O₂ (0≦x, y≦1 and x+y≦1), LiNi_{0.8}Co_{0.15}Al_{0.05}O₂, LiNi_{0.78}Co_{0.19}Al_{0.03}O₂, LiNi_{0.78}Co_{0.19}Al_{0.03}MₓO₂ (x=0.0001-0.05, M=alkali metals or alkaline earth metals), LiFePO₄, Li₂FeP₂O₇, LiCoPO₄, Li₁₊ₓM_{y}Mn_{2-x-y}O₄ (M=Al, Cr, Ga), LiTiS₂, Li₂V₂O₅, LiV₃O₈, Li₂TiS₃, Li₃NbSe₃, Li₂TiO₃, sulfur, polysulfides and/or sulfur-containing materials. The materials may be present in the form of micro- or nanoparticles. With materials of this kind, it is possible to create positive electrodes.

In a further preferred embodiment of the composition, the electrode material is selected from the group of natural or synthetic graphite, hard carbon having a stable unordered structure composed of very small and thin carbon platelets crosslinked with one another, soft, (substantially) graphitic carbon, silicon, silicon alloys, silicon-containing mixtures, lithium titanate (Li₂TiO₃ or Li₄TiO₅O₁₂), tin alloys, Co₃O₄, Li_{2.6}Co_{0.4}N and/or tin oxide (SnO₂). The materials may be present in the form of micro- or nanoparticles. With materials of this kind, it is possible to create negative electrodes.

It is likewise preferable that the binder is selected from the group of poly(vinylidene fluoride) (PVdF), carboxymethyl celluloses (CMCs), types of butadiene rubber, for example styrene-butadiene rubber (SBR), acrylonitrile-butadiene rubber, polyacrylic acid or combinations thereof.

Explicitly preferred is the combination of NMP as dispersion medium with PVP, ethyl cellulose, methyl cellulose, polyvinylpyridine, polystyrene or polyvinylpyridine-polystyrene block copolymers as dispersing aids and PVdF as binder.

Even more preferred is the combination of NMP as dispersion medium with PVP, ethyl cellulose, methyl cellulose, polyvinylpyridine, polystyrene or polyvinylpyridine-polystyrene block copolymers as dispersing aids, PVdF as binder and NMC as electrode material.

Also preferred is the combination of water as dispersion medium with CMC or PVP as dispersing aid and SBR or polyacrylic acid as binder. Some of these materials are effective both as dispersing aid and as binder. Thus, in this invention, any material shall not be restricted to just one of these functions. For example, polyacrylic acid is effective as dispersing aid and is used simultaneously as a binder, for example for anodes in Li ion batteries for (see, for example, in A. Magasinski et al.; ACS Appl Mater Interfaces. 2010 Nov; 2(11):3004-10. doi: 10.1021/am100871y). According to the invention, a combination of polyacrylic acid and CMC in which small amounts of CMC are used can greatly improve stabilization compared to the use of pure polyacrylic acid.

The present invention further relates to a process for producing an electrode, comprising the steps of
providing a composition of the invention (“slurry”). Optionally, particulate graphite or conductive carbon black may be added to the mixture as conductive material;
applying the mixture to an output conductor;
at least partly removing liquid substances from the mixture applied beforehand.

The electrode is first produced by coating the output conductor. This can be achieved by the operation of casting, bar coating or printing of the slurry onto the electrode output, followed by a drying step and subsequent calendering. The calendering is effected in such a way as to assure a maximum density of the electrode material with simultaneously good pore structure, in order to assure effective ion diffusion during the charging and discharging operation. The electrode material layer should preferably feature good adhesion of the coating on the output conductor. As already mentioned, preference is given to aluminum for the positive electrode and copper for the negative electrode in the output conductors.

The present invention further provides an electrode obtainable by a process of the invention, and an electrochemical element comprising an electrode of the invention, wherein the element is preferably a battery or an accumulator.

The present invention is illustrated in detail by the examples and figures which follow, but without being restricted thereto.

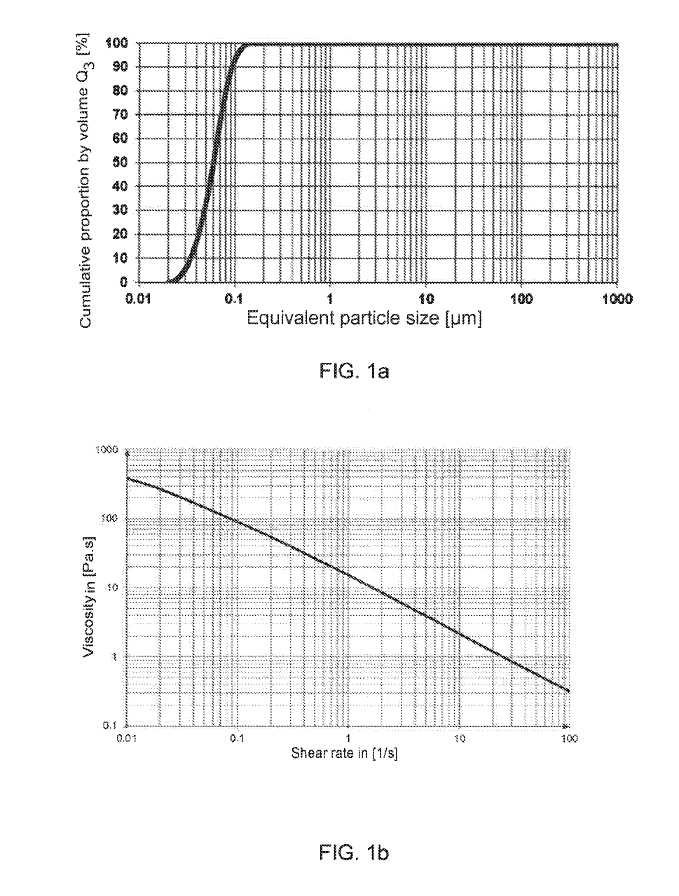

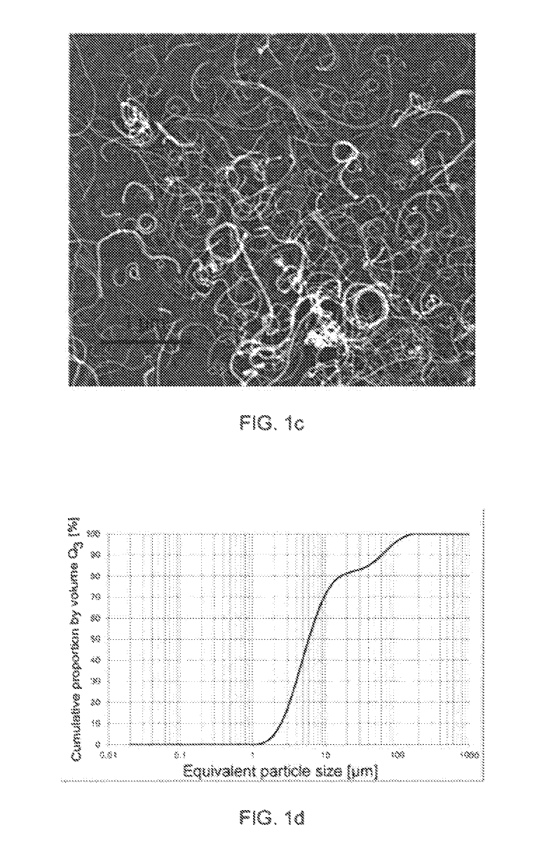

FIG. 1a shows the particle size distribution for an inventive dispersion

FIG. 1b shows the viscosity of an inventive dispersion

FIG. 1c shows a transmission electron micrograph of an inventive dispersion

FIG. 1d shows the particle size distribution for a noninventive dispersion

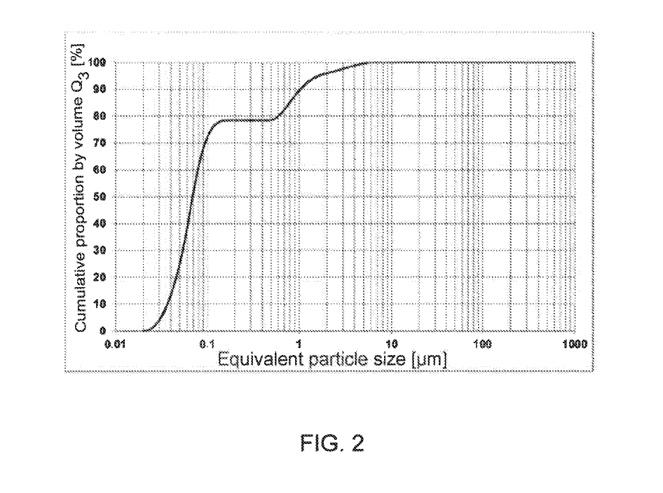

FIG. 2 shows the particle size distribution for an inventive dispersion

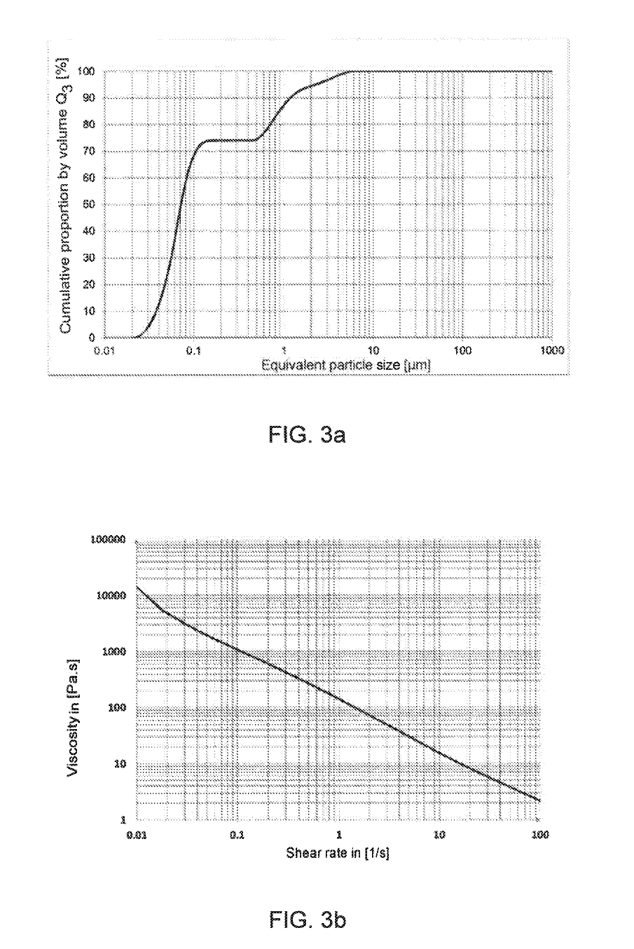

FIG. 3a shows the particle size distribution for an inventive dispersion

FIG. 3b shows the viscosity of an inventive dispersion

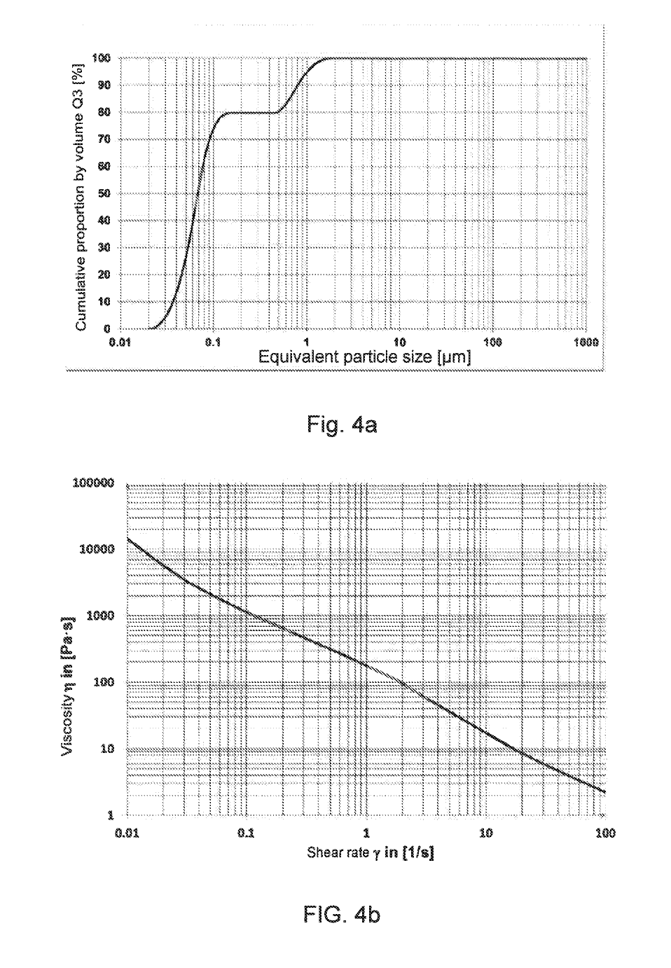

FIG. 4a shows the particle size distribution for an inventive dispersion

FIG. 4b shows the viscosity of an inventive dispersion

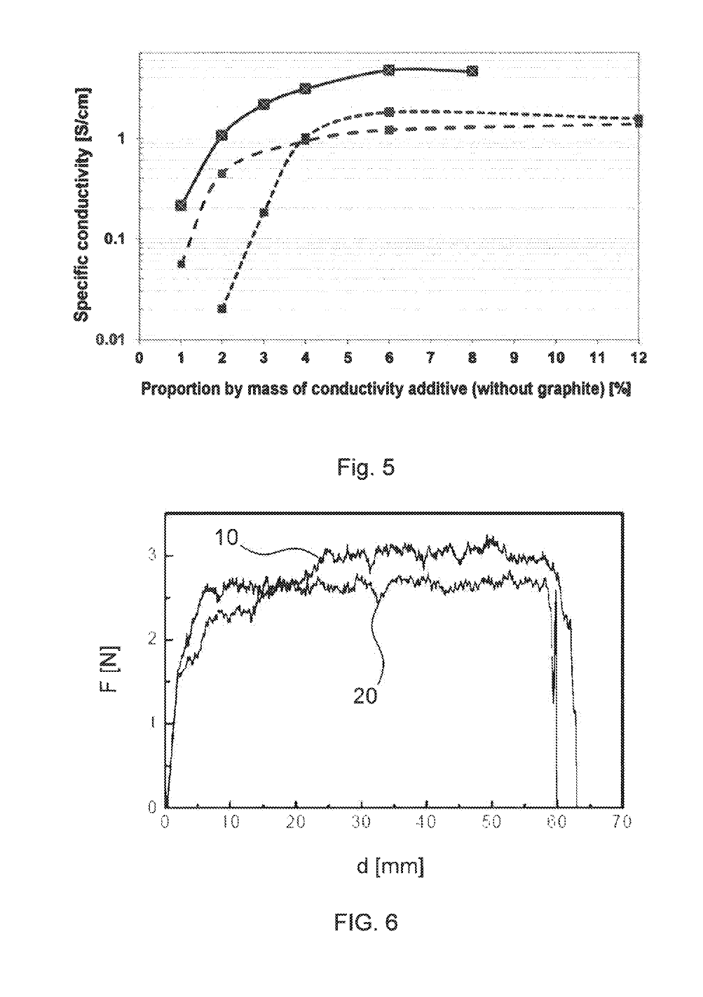

FIG. 5 shows the specific conductivity of electrodes produced from inventive CNT dispersions, from noninventive CNT dispersions and with conductive carbon black as conductivity additive

FIG. 6 shows the results of adhesion tests on inventive and noninventive electrodes

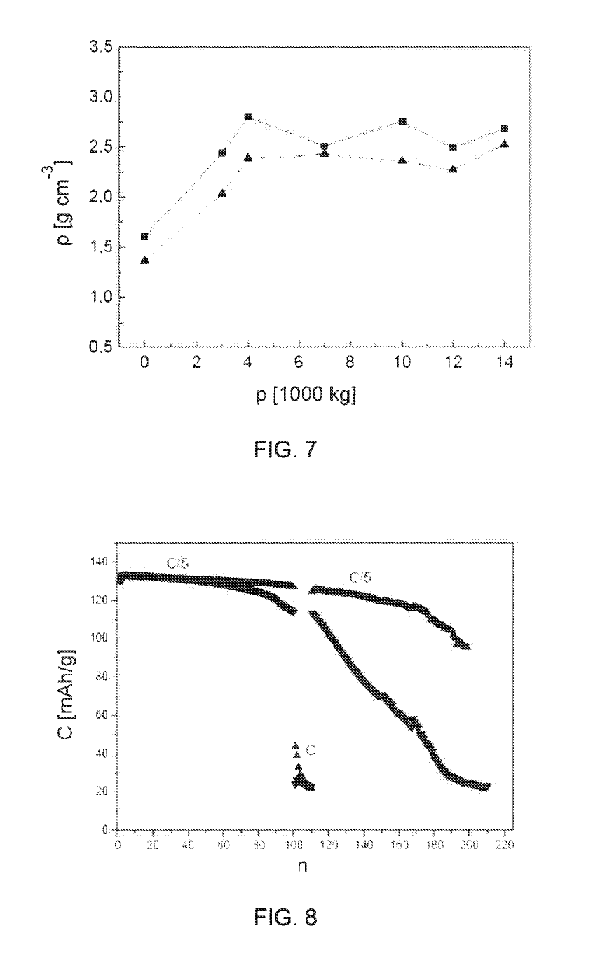

FIG. 7 shows different loading densities of inventive and noninventive electrodes

FIG. 8 shows discharge capacities in consecutive cycles with batteries produced with inventive and noninventive electrodes

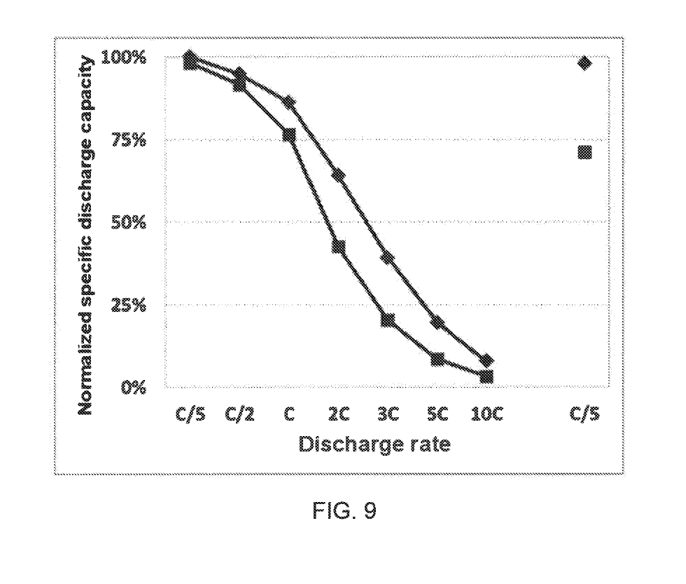

FIG. 9 shows the normalized specific discharge capacity for various discharge currents in batteries produced with inventive and noninventive electrodes

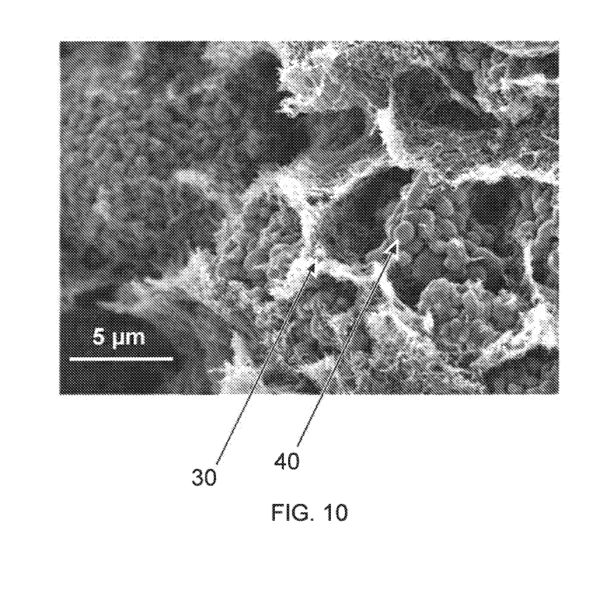

FIG. 10 shows an SEM image of an inventive electrode material

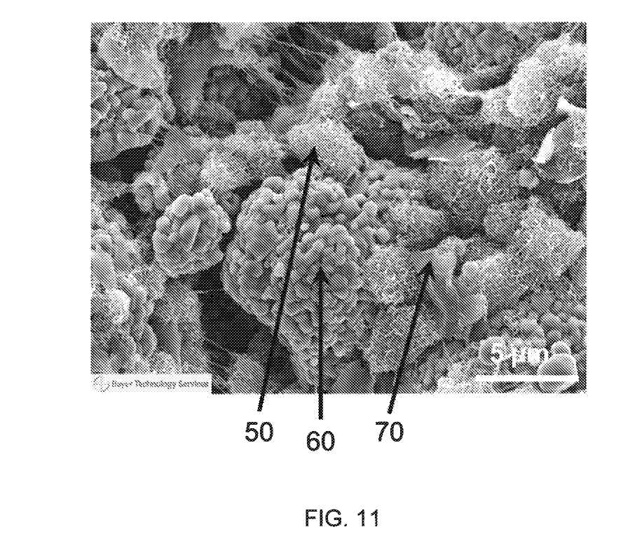

FIG. 11 shows an SEM image of a noninventive electrode material

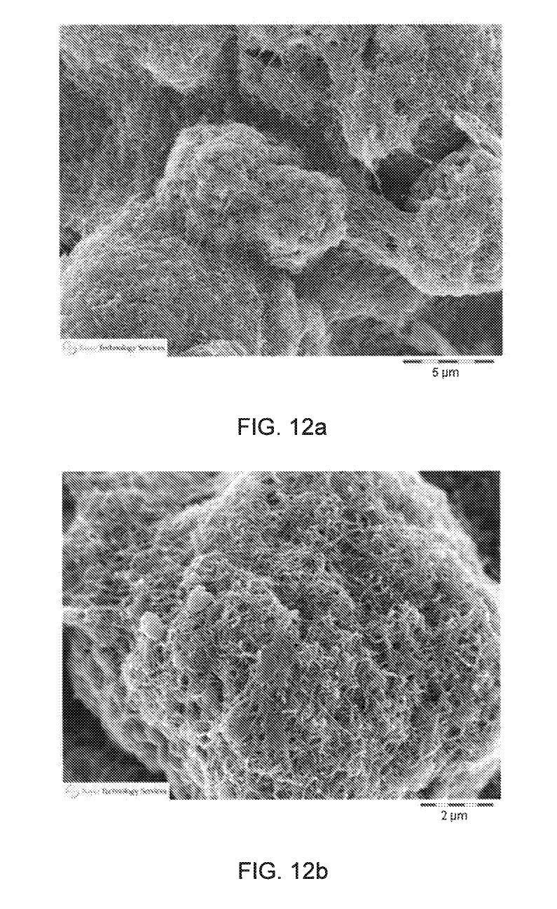

FIG. 12a, 12b show further SEM images of the surface of an inventive electrode material

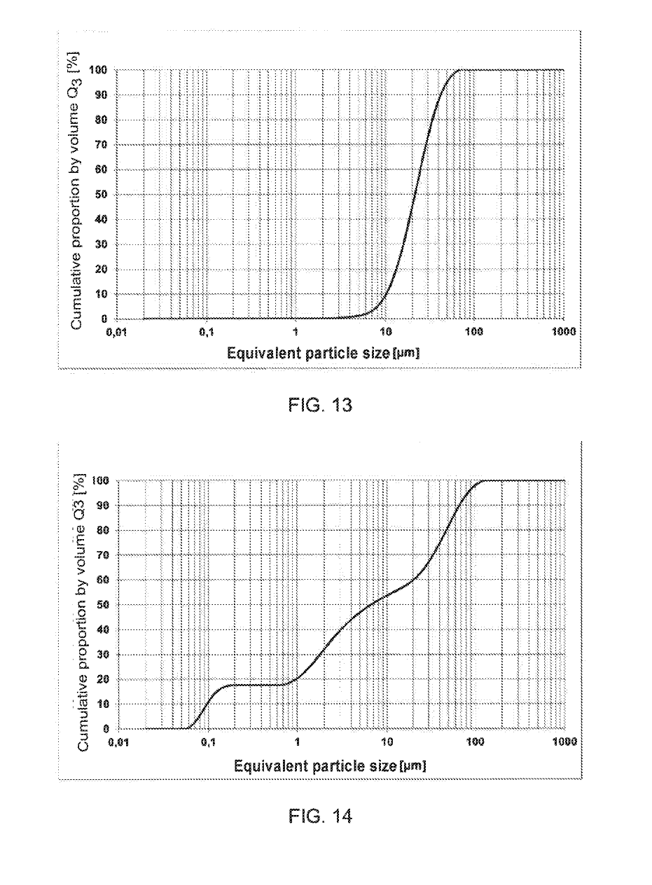

FIG. 13 shows the particle size distribution for a comparative example

FIG. 14 shows the particle size distribution for a further comparative example

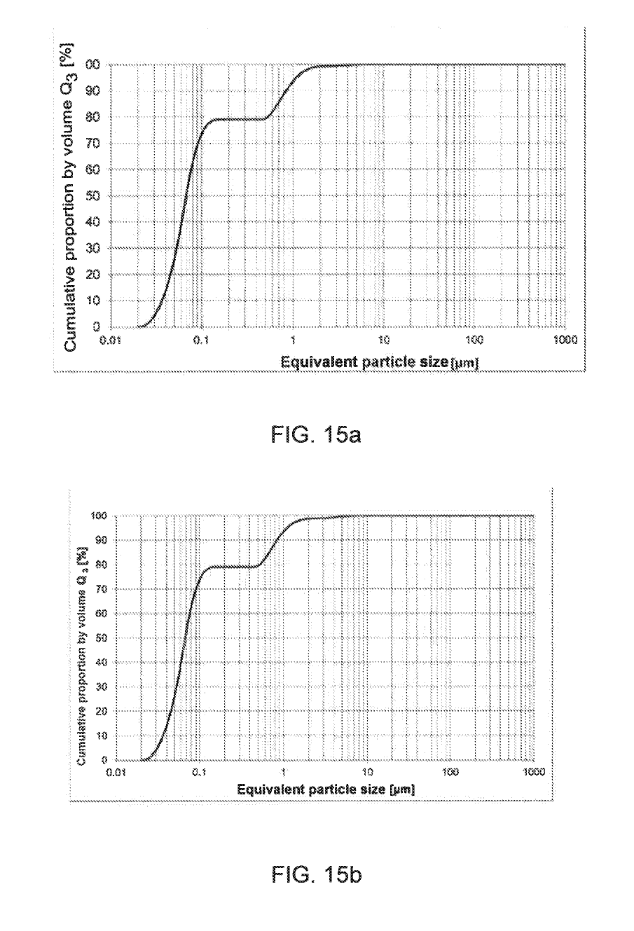

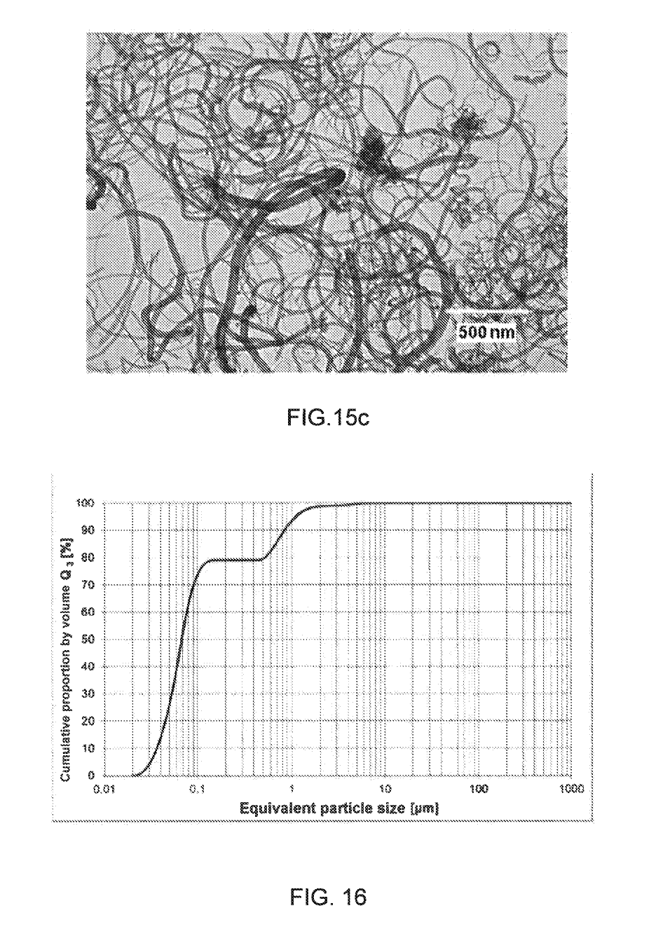

FIG. 15a shows the particle size distribution for an inventive dispersion

FIG. 15b shows the viscosity of an inventive dispersion

FIG. 15c shows a transmission electron micrograph of an inventive dispersion

FIG. 16 shows the particle size distribution for an inventive dispersion

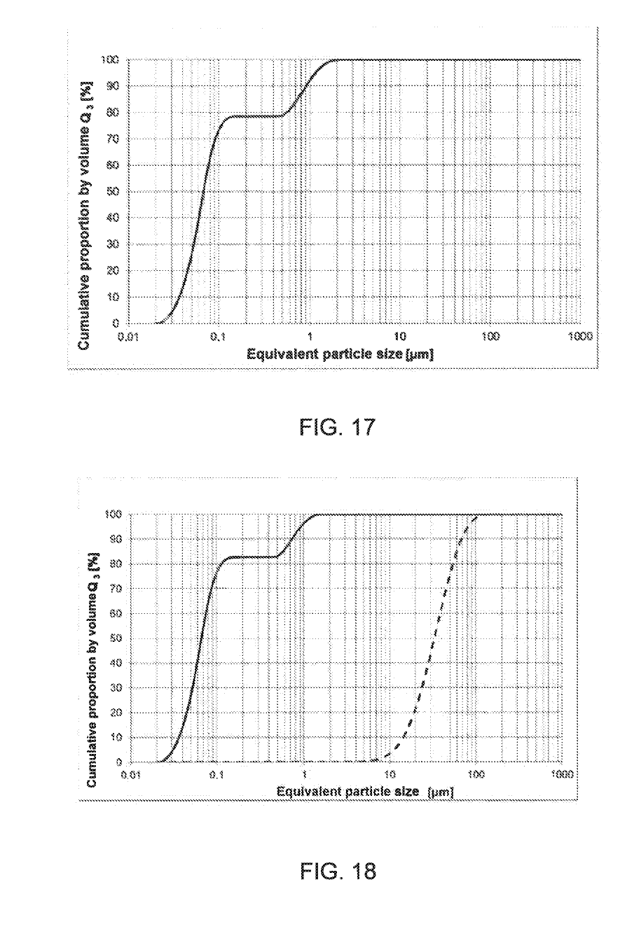

FIG. 17 shows the particle size distribution for an inventive dispersion

FIG. 18 shows the particle size distribution for inventive dispersions

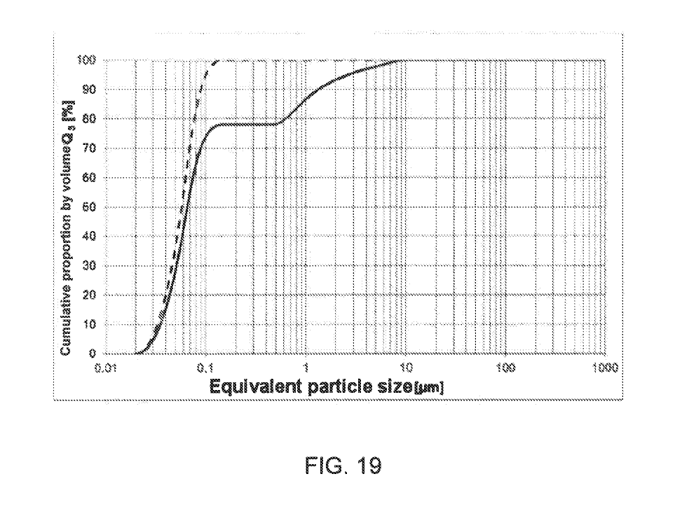

FIG. 19 shows the particle size distribution for inventive dispersions

The abbreviation “NMC” is used for the active electrode material LiNi_{0.33}Mn_{0.33}Co_{0.33}O₂ (Toda Kogyo Corp. Japan). PVDF stands for polyvinylidene fluoride (PVDF, SOLEF® 5130/1001, Solvay), PVP stands for polyvinylpyrrolidone (PVP K30, Sigma-Aldrich 81420), NMP stands for 1-methyl-2-pyrrolidnone (Sigma-Aldrich 328634), CMC stands for carboxymethyl cellulose (Walocel CRT 30G, Dow Chemicals). “SuperP®Li” is a commercially available conductive carbon black (TIMCAL Graphite & Carbon, Switzerland). Unless stated otherwise, CNTs used were Baytubes C70P (Bayer MaterialScience, Leverkusen) having a bulk density of about 70 g/dm³ and having a specific BET surface area of about 130 m²/g, or Baytubes C150P (Bayer MaterialScience, Leverkusen) having a bulk density of about 150 g/dm³ and having a specific BET surface area of about 210 m²/g.

### Example 1a

### Production of an Inventive Dispersion with NMP as Dispersion Medium

50 g of carbon nanotubes of the C70P type (Bayer MaterialScience, Leverkusen) having a specific BET surface area of about 130 m²/g were ground with a knife mill (Retsch, Grindomix GM300) for 60 min. 5 g of polyvinylpyrrolidone (PVP K30, Sigma-Aldrich 81420) were dissolved completely in 945 g of 1-methyl-2-pyrrolidinone (Sigma-Aldrich 328634) while stirring. The ground material was subsequently mixed with the prepared solution and homogenized with a rotor-stator system (Fluid Kotthoff GmbH) for 90 min. Thereafter, the material was introduced into a reservoir vessel which was equipped with a stirrer and from which this material was sent to a jet disperser. The jet disperser was equipped with a circular nozzle having a diameter of 0.5 mm. A pump conveyed the dispersion through the nozzle orifice at a pressure of 160 bar and then back into the reservoir vessel. After 60 passes, a nozzle having a diameter of 0.4 mm was used, the pressure was increased to 190 bar, and the dispersing operation was conducted for a further 60 passes. The total energy input based on the mass of CNTs was about 42 000 kJ/kg.

### Analysis Results.

FIG. 1a shows the particle size distribution for a dispersion obtained according to example 1a. The data were obtained by means of laser diffraction on a Malvern Mastersizer MS2000 Hydro MU system. In FIG. 1a, the cumulative volume fraction Q₃ is plotted against the equivalent particle size. In the particle size distribution of carbon nanotubes by means of laser diffraction, it has to be taken into account that, because of the narrow, elongated shape of the CNTs, it is only possible to obtain an equivalent particle size for an assumed spherical morphology. The volume-based fraction of particles having a size of ≦1 μm is nearly 100%.

FIG. 1b shows the results of a viscosity measurement for a dispersion obtained according to example 1a. The data were recorded with an Anton Paar rheometer (MCR series). It is possible to see the structurally viscous behavior of the dispersion in a viscosity range having good processibility according to the invention.

FIG. 1c shows a transmission electron micrograph of a dispersion produced according to example 1a. The white bar in the lower left-hand corner of the image represents the scale of 1 μm. It is possible to see the high level of individualization and the high proportion of CNTs with little fragmentation. In qualitative terms, it is directly clear from FIG. 1c that ≧70% by weight of the CNTs have a length of more than 200 nm, which is an important prerequisite for the formation of a homogeneous CMT network in the electrode.

### Example 1b

### Comparative Example

50 g of carbon nanotubes of the C70P type (Bayer MaterialScience, Leverkusen) having a specific BET surface area of about 130 m²/g were ground with a knife mill (Retsch, Grindomix GM300) for 90 min. 5 g of polyvinylpyrrolidone (PVP K30, Sigma-Aldrich 81420) were dissolved completely in 945 g of 1-methyl-2-pyrrolidinone (Sigma-Aldrich 328634) while stirring. The ground material was subsequently mixed with the prepared solution and homogenized with a rotor-stator system (Fluid Kotthoff GmbH) for 90 min. This dispersion was not treated with an HPD system and is therefore not inventive.

### Analysis Results:

FIG. 1d shows the particle size distribution for a dispersion obtained according to example 1b. The data were obtained by means of laser diffraction on a Malvern Mastersizer MS2000 Hydro MU system. In FIG. 1d, the cumulative volume fraction Q₃ is plotted against the equivalent particle size. In the particle size determination of carbon nanotubes by means of laser diffraction, it has to be taken into account that, because of the narrow, elongated shape of the CNTs, it is only possible to obtain an equivalent particle size for an assumed spherical morphology. The volume-based fraction of particles having a size of ≦1 μm is nearly 0%, i.e. virtually absent. Therefore, the dispersion produced in comparative example 1b is not inventive.

### Example 2

### Production of an Inventive Dispersion with NMP as Dispersion Medium

6 g of carbon nanotubes of the C150P type (Bayer MaterialScience, Leverkusen) having a higher bulk density of about 150 g/dm³ compared to the C70P type and having a specific BET surface area of about 210 m²/g were ground with a knife mill (Retsch, Grindomix GM300) for 60 min. 1.2 g of polyvinylpyrrolidone (PVP K30) (Sigma-Aldrich 81420) were dissolved completely in 192.8 g of 1-methyl-2-pyrrolidinone (Sigma-Aldrich 328634) while stirring. The ground material was subsequently mixed with the prepared solution and homogenized with a rotor-stator system (Fluid Kotthoff GmbH) for 90 min. Thereafter, the material was dispersed with the batchwise Micron LAB 40 homogenizer (APV Gaulin Deutschland GmbH, Lübeck, Germany) at a pressure of 1000 bar. The dispersing operation was repeated twice. The total energy input based on the mass of CNTs was about 10 000 kJ/kg.

### Analysis Results:

FIG. 2 shows the particle size distribution for a dispersion obtained according to example 2. The data were obtained by means of laser diffraction on a Malvern Mastersizer MS2000 Hydro MU system. In FIG. 2, the cumulative volume fraction Q₃ is plotted against the equivalent particle size. The volume-based fraction of particles having a size of ≦1 μm is about 89%. In the particle size determination of carbon nanotubes by means of laser diffraction, it has to be taken into account that, because of the narrow, elongated shape of the CNTs, it is only possible to obtain an equivalent particle size for an assumed spherical morphology.

### Example 3

### Production of an Inventive Dispersion with Solids Content 10% and with Water as Dispersion Medium

20 g of carbon nanotubes of the C70P type (Bayer MaterialScience, Leverkusen) having a specific BET surface area of about 130 m²/g were ground with a knife mill (Retsch, Grindomix GM300) for 60 min. 2 g of carboxymethyl cellulose (CMC, CRT30G, Dow Chemicals) were dissolved completely in 178 g of water while stirring. The ground material was subsequently mixed with the prepared solution and homogenized with a rotor-stator system (Fluid Kotthoff GmbH) for 90 min, Thereafter, the material was dispersed with the batchwise Micron LAB 40 homogenizer (APV Gaulin Deutschland GmbH, Lübeck, Germany) at a pressure of 1000 bar. The dispersing operation was repeated 11 times. The total energy input based on the mass of CNTs was about 12 000 kJ/kg.

### Analysis Results:

FIG. 3a shows the particle size distribution for a dispersion obtained according to example 3. The data were obtained by means of laser diffraction on a Malvern Mastersizer MS2000 Hydro MU system. In FIG. 3a, the cumulative volume fraction Q₃ is plotted against the equivalent particle size. The volume-based fraction of particles having a size of ≦1 μm is about 87%. In the particle size determination of carbon nanotubes by means of laser diffraction, it has to be taken into account that, because of the narrow, elongated shape of the CNTs, it is only possible to obtain an equivalent particle size for an assumed spherical morphology. FIG. 3b shows the viscosity for a dispersion obtained according to example 3. The data were recorded with an Anton Paar rheometer (MCR series). It is possible to see the structurally viscous behavior of the dispersion in a high viscosity range, but one still having good processibility.

### Example 4

### Production of an Inventive Dispersion with Solids Content 10%, with Water as Dispersion Medium and with a Mixture of Dispersing Aids

20 g of carbon nanotubes of the C70P type (Bayer MaterialScience, Leverkusen) having a specific BET surface area of about 130 m²/g were ground with a knife mill (Retsch, Grindomix GM300) for 60 min. 1 g of carboxymethyl cellulose (CMC, CRT30G, Dow Chemicals) and 1 g of polyvinylpyrrolidone (PVP K30, Sigma-Aldrich 81420) were dissolved completely in 178 g of water while stiffing. The ground material was subsequently mixed with the prepared solution and homogenized with a rotor-stator system (Fluid Kotthoff GmbH) for 90 min. Thereafter, the material was dispersed with the batchwise Micron LAB 40 homogenizer (APV Guilin Deutschland GmbH, Lübeck, Germany) at a pressure of 1000 bar. The dispersing operation was repeated 11 times. The total energy input based on the mass of CNTs was about 12 000 kJ/kg.

### Analysis Results:

FIG. 4a shows the particle size distribution for a dispersion obtained according to example 4. The data were obtained by means of laser diffraction on a Malvern Mastersizer MS2000 Hydro MU system. In FIG. 4a, the cumulative volume fraction Q₃ is plotted against the equivalent particle size. The volume-based fraction of particles having a size of ≦1 μm is about 95%. In the particle size determination of carbon nanotubes by means of laser diffraction, it has to be taken into account that, because of the narrow, elongated shape of the CNTs, it is only possible to obtain an equivalent particle size for an assumed spherical morphology. It can be seen here that a mixture of dispersing aids enables a gradually somewhat higher level of individualization of the CNTs in the dispersion. FIG. 4b shows the viscosity for a dispersion obtained according to example 4. The data were recorded with an Anton Paar rheometer (MCR series). It is possible to see the structurally viscous behavior of the dispersion in a high viscosity range, but one still having good processibility, according to the invention.

### Example 5

### Production of Inventive Slurries From a Dispersion According to Example 1 with Different Proportions by Mass of Carbon Nanotubes

3 g of polyvinylidene fluoride (PVDF, SOLEF® 5130/1001, Solvay) were dissolved in about 25 mL of 1-methyl-2-pyrrolidinone (NMP, Sigma-Aldrich 328634) by stirring (about 500 rpm) at 30° C. for 4 h. Added to this NMP/PVDF solution are 30 g of the dispersion from example 1 which contained an amount of 1.5 g of CNTs, and the mixture was stirred at room temperature for about 2.5 h (about 2000 rpm). Thereafter, a further 44.5 g NMC active material (NM 3100, Toda Kogyo Corp.) and 1.0 g of graphite (KS6L, from Timcal) were added and stirring was continued at 700 rpm for 60 min. The solids content of this slurry was 50 g, and the solid component contained 6% by weight of PVDF, 3% by weight of CNTs, 0.3% by weight of polyvinylpyrrolidone, 2% by weight of graphite and 88.7% by weight of NMC active material. By varying the amount of dispersion from example 1 added, it is possible to increase or reduce the amount of CNTs in the slurry over a wide range. In a corresponding manner, it is necessary in each case to adjust the amount of NMC active material added, in order that the total solids content is again 50 g. In this way, with the same amount of PVDF and graphite, the CNT content can be varied over a wide range.

### Example 6

### Comparative example: Production of Noninventive Slurry Having Different Proportions of Conductive Additive Consisting of Conductive Carbon Black

3 g of polyvinylidene fluoride (PVDF, SOLEF® 5130/1001, Solvay) were dissolved in about 50 mL of 1-methyl-2-pyrrolidinone (NMP, Sigma-Aldrich 328634) by stirring (about 500 rpm) at 130° C. for 4 h. Added to this NMP/PVDF solution were 3 g of conductive carbon black (SuperP Li, Timcal), and the mixture was stirred (about 2000 rpm) at room temperature for about 2.5 h. Thereafter, a further 43 g of

NMC active material (NM 3100, Toda Kogyo Corp.) and 1.0 g of graphite (KS6L, from Timcal) were added and stirring was continued at 700 rpm for 60 min. The solids content of this slurry was 50 g, and the solid component contained 6% by weight of PVDF, 6% by weight of conductive carbon black, 2% by weight of graphite and 86% by weight of NMC active material. By varying the amount of conductive carbon black added, it is possible to increase or reduce the amount of conductivity additive in the slurry over a wide range. In a corresponding manner, it is necessary in each case to adjust the amount of NMC active material added, in order that the total solids content is again 50 g. In this way, with the same amount of PVDF and graphite, the conductive carbon black content can be varied over a wide range.

### Example 6b

### Comparative Example: Production of Noninventive Slurry Having Different Proportions of Carbon Nanotubes

3 g of polyvinylidene fluoride (PVDF, SOLEF® 5130/1001, Solvay) were dissolved in about 50 mL of 1-methyl-2-pyrrolidinone (NMP, Sigma-Aldrich 328634) by stirring (about 500 rpm) at 30° C. for 4 h. Added to this NMP/PVDF solution were 3 g of carbon nanotubes (Baytubes C70P, Bayer Material Science), which had been ground beforehand with a knife mill (Retsch, Grindomix GM300) for 60 min., and the mixture was stiffed (about 2000 rpm) at room temperature for about 2.5 h. The dispersion containing carbon nanotubes was not treated with a high-pressure homogenizer, and CNTs did not have the size properties according to the invention. Thereafter, a further 43 g of NMC active material (NM 3100, Toda. Kogyo Corp.) and 1.0 g of graphite (KS6L, from Timcal) were added and stirring was continued at 700 rpm for 60 min. The solids content of this slurry was 50 g, and the solid component contained 6% by weight of PVDF, 6% by weight of conductive carbon black, 2% by weight of graphite and 86% by weight of NMC active material. By varying the amount of carbon nanotubes added, it is possible to increase or reduce the amount of conductivity additive in the slurry over a wide range. In a corresponding manner, it is necessary in each case to adjust the amount of NMC active material added, in order that the total solids content is again 50 g. In this way, with the same amount of PVDF and graphite, the carbon nanotube content can be varied over a wide range.

### Example 7

### Production of Inventive Electrodes Having Different Proportions of Conductive Additive

If necessary, the slurry from example 5 was diluted with 1-methyl-2-pyrrolidinone (NMP, Sigma Aldrich 328634) to such an extent that it had a viscosity between about 5 and about 30 Pa·s at a shear rate of 1/s (measured with Anton Paar rheometer, MCR series). Subsequently, the slurry was coated onto an aluminum foil of thickness 30 μm with a coating bar (target value for wet film thickness: 120 μm). This film was subsequently dried at 60° C. for 18 hours. Subsequently, this dried film was pressed (calendered) at a pressure of 7000 kg/cm².

### Example 8

### Production of Noninventive Electrodes Having Different Proportions of Conductive Additive

If necessary, the slurries from examples 6a and 6b (comparative examples) were diluted with 1-methyl-2-pyrrolidinone (NMP, Sigma-Aldrich 328634) to such an extent that they had a viscosity between about 5 and about 30 Pa·s at a shear rate of 1/s (measured with Anton Paar rheometer, MCR series). Subsequently, the slurries were coated onto an aluminum foil of thickness 30 μm with a coating bar (target value for wet film thickness: 120 μm). These films were subsequently dried at 60° C. for 18 hours. Subsequently, these dried films were pressed (calendered) at a pressure of 7000 kg/cm².

### Example 9

### Conductivity of the Electrodes

To measure the conductivities, the inventive slurry (example 5) which is suitable for production of an electrode (example 7) was applied to a glass pane by means of a coating bar (target value for wet film thickness: 120 μm) and dried at 60° C. for 18 hours. Various films having different contents of carbon nanotubes from the inventive dispersions were used, such that the dried films consisted of 6% by weight of PVDF, 2% by weight of graphite, and 1%, 2%, 3%, 4%, 6%, 8% or 12% by weight of carbon nanotubes from the inventive dispersions. The respective difference from 100% by weight consisted of polyvinylpyrrolidone (in each case 1/10 of the proportion of carbon nanotubes) and active material NMC. Subsequently, the specific resistivities were measured by the 4-point method known to those skilled in the art.

For comparison, electrode films were produced under the same conditions, except that, rather than inventive slurries containing carbon nanotubes (example 5), noninventive slurries containing conductive carbon black (SuperP Li, Timcal) (example 6a) or the carbon nanotubes from the noninventive dispersions (example 6b) were used.

### Analysis Results:

FIG. 5 shows the specific conductivity of films produced according to example 9. The films consisted of 6% by weight of PVDF, 2% by weight of graphite, and 1%, 2%, 3%, 4%, 6%, 8% or 12% by weight of carbon nanotubes from the inventive dispersion (solid line) or from the noninventive dispersion containing carbon nanotubes (short-dashed line) or conductive carbon black from the noninventive dispersion (long-dashed line). What is clearly evident is that the specific conductivity of the electrode materials is several times greater over wide ranges when the inventive dispersion comprising carbon nanotubes or the slurry produced therefrom according to example 5 is used rather than conductive carbon black or rather than carbon nanotubes dispersed in a noninventive manner. The higher conductivity is an important prerequisite for a higher power density of an electrochemical element (e.g. battery) which has been produced using the inventive dispersion.

### Example 10

### Adhesion Tests

Electrodes as described in examples 7 and 8 were provided with a 10 mm-wide adhesive strip on the electrode which was pulled off with a tensile tester. In doing so, the tensile force and hence the adhesion to the substrate was measured. The measurement was effected to DIN EN ISO 11339. The results are shown in FIG. 6, which relates the force F to the distance d over which the adhesive strip is pulled off the substrate. In this figure, the upper curve 10 represents the measurements for the inventive electrode material and the lower curve 20 the measurements for the comparative material. The higher adhesion of the inventive electrode compared to the comparative electrode is clearly evident.

### Example 11

### Loading Densities

Electrode materials were produced in a similar process to that described in examples 7 and 8. The composition of the inventive electrode was 89.8% by weight of NMC active material (Nr,13100, Toda Kogyo Corp.), 6.9% by weight of PVDF (Solef 5130, Solvay), 0.3% by weight of polyvinylpyrrolidone and 3% by weight of carbon nanotubes from the inventive dispersion. The composition of the noninventive electrode was 89.8% by weight of NMC active material (NM3100, Toda Kogyo Corp.), 6.9% by weight of PVDF (Solef 5130, Solvay) and 3.3% by weight of conductive carbon black (SuperP Li, Timcal). The electrode films were pressed together (calendered) under various pressures and the density σ was determined by determining the mass of the electrode layer and the layer thickness of the resultant test specimens. The results are shown in FIG. 7. The squared data points “▪” relate to the inventive material and the triangular data points “▴” to the comparative material. The higher density of the inventive electrode is clearly apparent, which can be an important indicator of a higher energy density.

### Example 12

### Cycling

In this example, inventive and noninventive electrodes as described in examples 7 and 8 (noninventive example 8 was based on the dispersion of example 6a) were examined with regard to their behavior on repeated charging and discharging. For this purpose, a model system in the form of a button cell with a lithium anode and a cathode composed of LiNi_{0.33}Mn_{0.33}Co_{0.33}O₂ (NMC) (NM3100, Toda Kogyo Corp.) was, The composition of the inventive cathode was 85.7% by weight of NMC, 6% by weight of CNTs from the inventive dispersion, 2% by weight of graphite (SG6L, Timcal), 0.3% by weight of polyvinylpyrrolidone (K30, Aldrich) and 6% by weight of PVDF binder. The composition of the noninventive comparative cathode was 86% by weight of NMC, 3% by weight of SuperP Li, 2% by weight of graphite (SG6L, Timcal) and 7.2% by weight of PVDF binder. Thus, cells which contain the inventive electrodes and the comparative electrodes but are otherwise of the same design were available. The particle size of the NMC particles was 5-10 μm, the layer thickness of the electrode 60-70 μm and the density of the electrode about 2.8 g/cm³. The electrolyte used was LP 30 Selectipur from Merck KGaA (1 M LiPF₆ in a 1:1 ethylene carbonate/dimethyl carbonate (EC/DMC) mixture).

FIG. 8 shows the discharge capacity as a function of the number of charge/discharge cycles n. The charge and discharge current is C/5, meaning that the full capacity was charged and discharged homogeneously over a period of 5 h. After 100 cycles, a charge and discharge current of C was set for 10 cycles, meaning that the full capacity was then charged and discharged homogeneously over a period of 1 h. This procedure does show a distinct drop in capacity at high discharge currents, but also good regeneratability of the two systems after the return to low discharge currents. Data points with triangles pointing upward “▴” are for inventive electrodes, and those with triangles pointing downward “▾” for the comparative example. It is clearly apparent that there is much higher cycling stability in a battery containing CNTs as conductivity additive compared to the comparative battery based on conductive carbon black as additive. This example leads to the conclusion of a longer lifetime of a battery based on CNTs.

### Example 13

### Stressability

Inventive and noninventive electrodes as described in principle in examples 7 and 8 were processed into button cells as described in principle in example 12. Only the composition was changed as follows. The composition of the inventive cathode was 89.5% by weight of NMC, 3% by weight of CNTs from the inventive dispersion, 0.3% of polyvinylpyrrolidone and 7.2% by weight of PVDF binder. The composition of the noninventive comparative cathode was 89.8% by weight of NMC, 3% by weight of SuperP Li and 7.2% by weight of PVDF binder. Thus, cells which contain the inventive electrodes and the comparative electrodes but are otherwise of the same design were available. The cells were then subjected to charge and discharge currents ranging from C/5 (full capacity in 5 h) up to IOC (10 full capacities in 1 h). Each data point is calculated from the mean of five successive individual measurements with the same discharge rate.

FIG. 9 shows the normalized specific discharge capacity for various discharge currents of C/5 to 10C, and the capacity still available at the minimum discharge current after the maximum discharge current. The diamond-shaped data points “♦” are for the inventive electrode and square data points “▪” for the comparative example. It is clearly apparent that, under the same conditions, the decline in capacity at increasing discharge currents is smaller, which suggests lower internal resistance of this battery and hence enables a higher power density. It can also be seen that the battery with the noninventive electrode has suffered a distinct loss of capacity (about 30%) after the treatment with the maximum discharge current, while the battery with the inventive electrode almost attains the starting value again. This behavior shows distinct improvement in behavior of a battery containing the inventive electrode when subjected to high stress.

FIG. 10 shows a scanning electron micrograph of the cross section of a crushed inventive electrode (not compressed). It was obtained in accordance with example 7, with a composition of 89.8% by weight of NMC, 2% by weight of CNTs, 2% by weight of graphite, 6% by weight of PVDF binder and 0.2% by weight of polyvinylpyrrolidone. It is possible to see a dense network of CNTs 30 covering the NMC particles 40 without any apparent agglomerate-like collections of CNTs. This optimal distribution of the CNTs assures effective, low-resistance conduction of the electrons away from the active material to the metallic output. At the same time, this elastic CNT network ensures that expansions and contractions in the active material during the charging and discharging operation does not lead to loss of electrical contacts from the active material to the output.

FIG. 11 shows a scanning electron micrograph of the cross section of a noninventive electrode (not compressed). It was obtained in accordance with example 8 (employing the slurry from example 6b), with a composition of 90% by weight of NMC, 2% by weight of CNTs, 2% by weight of graphite and 6% by weight of PVDF binder. The CNTs used are agglomerated here. It is possible to see the agglomerates 50, the NMC particles 60 and graphite particles 70. The CNT agglomerates concentrate a relatively large number of the CNTs present in tightly restricted areas, and so the overall conductivity of the electrode is poorer. This effect is also present at high CNT concentrations, but becomes all the more important at lower CNT concentrations in the electrode, since percolation pathways are then increasingly disrupted. This also explains the behavior in FIG. 5, where it is clearly visible how the conductivity decreases at low concentrations. At low concentrations, the electrodes produced from the noninventive dispersions behave similarly to electrodes containing conductive carbon black as additive. This is because no network surrounding the active material forms. There is also a corresponding explanation for the lower cyclability, as shown in FIG. 8.

FIGS. 12a and 12b show two scanning electron micrographs of the surface of an inventive electrode (not compressed). The composition of the electrode was 3% by weight of CNTs from the inventive dispersion., 0.3% by weight of polyvinylpyrrolidone (K30, Aldrich) and 6% by weight of PVDF binder.

### Example 14

### Comparative Example: Repetition of Example 3 from DE 10 2005 043 054 A1 (WO 2007/028369 A1)

10 g of carbon nanotubes of the Baytubes C150P type (Bayer MaterialScience, Leverkusen) having a specific BET surface area of about 210 m²/g, an external diameter of 13-16 nm and lengths of the individual carbon nanotubes of 1-10 μm were dispersed in 500 mL of 2-propanol without addition of further additives, so as to form a dispersion with solids content 1.96%. Thereafter, the material was dispersed with the batchwise Micron LAB 40 homogenizer (APV Gaulin Deutschland GmbH, Lübeck, Germany) at a pressure of 1000 bar in one run. The fact that only one dispersion run was conducted in DE 10 2005 043 054 A1 (WO 2007/028369 A1) is apparent from the wording “after the pass, the dispersion was . . . ” in the description of the example.

### Analysis Results:

FIG. 13 shows the particle size distribution for a dispersion obtained according to example 14. The data were obtained by means of laser diffraction on a Malvern Mastersizer MS2000 Hydro MU system. In FIG. 13, the cumulative volume fraction Q₃ is plotted against the equivalent particle size. The volume-based fraction of particles having a size of ≦1 μm is virtually absent and is in the region of below 2% and is thus well below the limits according to the invention. The median agglomerate size (d50) is about 22 μm, and the d90 exceeds 40 μm. In the particle size determination of carbon nanotubes by means of laser diffraction, it has to be taken into account that, because of the narrow, elongated shape of the CNTs, it is only possible to obtain an equivalent particle size for an assumed spherical morphology.

### Example 15

### Comparative Example: Production of a Noninventive Dispersion with N-Methylpyrrolidone as Dispersion Medium

1 g of polyvinylpyrrolidone (PVP K30, Sigma-Aldrich 81420) were dissolved completely in 499 g of 1-methyl-2-pyrrolidinone (Sigma-Aldrich 328634) while stirring. Subsequently, 10 g of carbon nanotubes of the Baytubes C150P type (Bayer MaterialScience, Leverkusen) having a specific BET surface area of about 210 m²/g, an external diameter of 13-16 nm and lengths of the individual carbon nanotubes of 1-10 μm were added to the solution, so as to form a dispersion with CNT solids content 1.96%. Thereafter, the material was dispersed with the batchwise Micron LAB 40 homogenizer (APV Gaulin Deutschland GmbH, Lübeck, Germany) at a pressure of 1000 bar in one pass.

### Analysis Results:

FIG. 14 shows the particle size distribution for a dispersion obtained according to example 15. The data were obtained by means of laser diffraction on a Malvern Mastersizer MS2000 Hydro MU system. In FIG. 14, the cumulative volume fraction Q₃ is plotted against the equivalent particle size. The volume-based fraction of particles having a size of ≦1 μm is about 20% and is thus well below the limits according to the invention. The size distribution is additionally very broad with a d50 of about 7 μm and a d90 of nearly 70 μm. In the particle size determination of carbon nanotubes by means of laser diffraction, it has to be taken into account that, because of the narrow, elongated shape of the CNTs, it is only possible to obtain an equivalent particle size for an assumed spherical morphology.

### Example 16

### Production of an Inventive Dispersion with NMP as Dispersion Medium and Ethyl Cellulose as Dispersing Aid

6 g of carbon nanotubes of the C70P type (Bayer MaterialScience, Leverkusen) having a specific BET surface area of about 130 m²/g were ground with a knife mill (Retsch, Grindomix GM300) for 60 min. 0.3 g of ethyl cellulose (EC, ETHOCELL Standard 100, Dow Wolff Cellulosics) was dissolved completely in 193.7 g of NMP while stirring. The ground material was subsequently mixed with the prepared solution and homogenized with a rotor-stator system (Fluid Kotthoff GmbH) for 90 min. Thereafter, the material was dispersed with the batchwise Micron LAB 40 homogenizer (APV Gaulin Deutschland GmbH, Lübeck, Germany) at a pressure of 1000 bar. The dispersing operation was repeated 5 times.

### Analysis Results:

FIG. 15a shows the particle size distribution for a dispersion obtained according to example 16. The data were obtained by means of laser diffraction on a Malvern Mastersizer MS2000 Hydro MU system. In FIG. 15a, the cumulative volume fraction Q₃ is plotted against the equivalent particle size. The volume-based fraction of particles having a size of ≦1 μm is about 95%. In the particle size determination of carbon nanotubes by means of laser diffraction, it has to be taken into account that, because of the narrow, elongated shape of the CNTs, it is only possible to obtain an equivalent particle size for an assumed spherical morphology.

FIG. 15b shows the viscosity for a dispersion obtained according to example 16. The data were recorded with an Anton Paar rheometer (MCR series). It is possible to see the structurally viscous behavior of the dispersion in a viscosity range having good processibility.

FIG. 15c shows a transmission electron micrograph of a dispersion produced according to example 15. The white bar in the lower right-hand corner of the image represents the scale of 500 nm. It is possible to see the high level of individualization and the high proportion of CNTs with little fragmentation. In qualitative terms, it is directly clear from FIG. 15c that EC also acts as an effective dispersing aid and that ≧70% by weight of the CNTs have a length of more than 200 nm, which is an important prerequisite for the formation of a homogeneous CMT network in the electrode.

### Example 17

### Production of an Inventive Dispersion with NMP as Dispersion Medium and EC as Dispersing Aid

40 g of carbon nanotubes of the C70P type (Bayer MaterialScience, Leverkusen) having a specific

BET surface area of about 130 m²/g, were ground with a knife mill (Retsch, Grindomix GM300) for 60 min. 4 g of ethyl cellulose (EC, ETHOCELL Standard 100,Dow Wolff Cellulosics) were dissolved completely in 956 g of 1-methyl-2-pyrrolidinone (Sigma-Aldrich 328634) while stirring. The ground material was subsequently mixed with the prepared solution and homogenized with a rotor-stator system (Fluid Kotthoff GmbH) for 90 min. Thereafter, the material was introduced into a reservoir vessel which was equipped with a stirrer and from which this material was sent to a jet disperser. The jet disperser was equipped with a circular nozzle having a diameter of 0.5 mm. A pump conveyed the dispersion through the nozzle orifice at a pressure of 250 bar and then back into the reservoir vessel. A total of 120 passes were conducted.

### Analysis Results:

FIG. 16 shows the particle size distribution for a dispersion obtained according to example 17. The data were obtained by means of laser diffraction on a Malvern Mastersizer MS2000 Hydro MU system. In FIG. 16, the cumulative volume fraction Q₃ is plotted against the equivalent particle size. In the particle size determination of carbon nanotubes by means of laser diffraction, it has to be taken into account that, because of the narrow, elongated shape of the CNTs, it is only possible to obtain an equivalent particle size for an assumed spherical morphology. The volume-based fraction of particles having a size of ≦1 μm is about 93%.

### Example 18

### Production of an Inventive Dispersion with NMP as Dispersion Medium and Methyl Cellulose as Dispersing Aid

6 g of carbon nanotubes of the C70P type (Bayer MaterialScience, Leverkusen) having a specific BET surface area of about 130 m²/g were ground with a knife mill (Retsch, Grindomix GM:300) for 60 min. 0.3 g of methyl cellulose (MC, Methocell, Sigma Aldrich) was dissolved completely in 193.7 g of NMP while stirring. The ground material was subsequently mixed with the prepared solution and homogenized with a rotor-stator system (Fluid Kotthoff GmbH) for 90 min. Thereafter, the material was dispersed with the batchwise Micron LAB 40 homogenizer (APV Gaulin Deutschland GmbH, Lübeck, Germany) at a pressure of 1000 bar. The dispersing operation was repeated 5 times.

### Analysis Results:

FIG. 17 shows the particle size distribution for a dispersion obtained according to example 18. The data were obtained by means of laser diffraction on a Malvern Mastersizer MS2000 Hydro MU system. In FIG. 17, the cumulative volume fraction Q₃ is plotted against the equivalent particle size. The volume-based fraction of particles having a size of ≦1 μm is about 93%. In the particle size determination of carbon nanotubes by means of laser diffraction, it has to be taken into account that, because of the narrow, elongated shape of the CNTs, it is only possible to obtain an equivalent particle size for an assumed spherical morphology.

### Example 19

### Production of an Inventive Dispersion with NMP as Dispersion Medium and Polyvinylpyridine as Dispersing Aid

6 g of carbon nanotubes of the C70P type (Bayer MaterialScience, Leverkusen) having a specific BET surface area of about 130 m²/g were ground with a knife mill (Retsch, Grindomix GM300) for 60 min. 0.6 g of poly(4-vinylpyridine) (Mw=60 000, Aldrich) was dissolved completely in 193.4 g of NMP while stirring. The ground material was subsequently mixed with the prepared solution and homogenized with a rotor-stator system (Fluid Kotthoff GmbH) for 90 min. Thereafter, the material was dispersed with the batchwise Micron LAB 40 homogenizer (APV Gaulin Deutschland GmbH, Lübeck, Germany) at a pressure of 1000 bar. The dispersing operation was repeated 5 times.

### Example 20

### Production of an Inventive Dispersion with NMP as Dispersion Medium and Polystyrene as Dispersing Aid

6 g of carbon nanotubes of the C70P type (Bayer MaterialScience, Leverkusen) having a specific BET surface area of about 130 m²/g were ground with a knife mill (Retsch, Grindomix GM300) for 60 min. 0.6 g of polystyrene (Mw=60 000, Aldrich) was dissolved completely in 193.4 g of NMP while stirring. The ground material was subsequently mixed with the prepared solution and homogenized with a rotor-stator system (Fluid Kotthoff GmbH) for 90 min. Thereafter, the material was dispersed with the batchwise Micron LAB 40 homogenizer (APV Gaulin Deutschland GmbH, Lübeck, Germany) at a pressure of 1000 bar. The dispersing operation was repeated 5 times.

### Example 21

### Production of an Inventive Dispersion with Water as Dispersion Medium and a Mixture of Polyacrylic Acid and CMC as Dispersing Aid

12 g of carbon nanotubes of the C70P type (Bayer MaterialScience, Leverkusen) having a specific BET surface area of about 130 m²/g were ground with a knife mill (Retsch, Grindomix GM300) for 6( ) min. 2.4 g of CMC (Mw=60 000, Aldrich) were dissolved completely in 385.6 g of water while stirring. The ground material was subsequently mixed with the prepared solution and homogenized with a rotor-stator system (Fluid Kotthoff GmbH) for 90 min. Thereafter, the material was dispersed with the batchwise Micron LAB 40 homogenizer (APV Gaulin Deutschland GmbH, Lübeck, Germany) at a pressure of 1000 bar. The dispersing operation was repeated 5 times. Subsequently, polyacrylic acid (PAA, Mw˜240 000, Sigma Aldrich) was adjusted to pH 8.5 with LiOH, such that an aqueous 28.8% solution was available. 100 g of this solution were subsequently mixed with 200 g of the carbon nanotube dispersion and dispersed once with the batchwise Micron LAB 40 homogenizer (APV Gaulin Deutschland GmbH, Lübeck, Germany) at a pressure of 1000 bar. A stable, finely distributed aqueous dispersion consisting of 2% by weight of carbon nanotubes, 9.6% polyacrylic acid and 0.4% CMC is obtained.

For a comparative dispersion, a process according to example 3 was employed, in which, rather than CMC, only PAA adjusted to pH 8.5 with LiOH was used.

### Analysis Results:

FIG. 18 shows the particle size distribution for a dispersion obtained according to example 21 (solid line). Shown for comparison is the particle size distribution of a dispersion which has been stabilized only with polyacrylic acid (dotted line). The data were obtained by means of laser diffraction on a Malvern Mastersizer MS2000 Hydro MU system. In FIG. 18, the cumulative volume fraction Q₃ is plotted against the equivalent particle size. The volume-based fraction of particles having a size of ≦1 μm is about 95%, in the particle size determination of carbon nanotubes by means of laser diffraction, it has to be taken into account that, because of the narrow, elongated shape of the CNTs, it is only possible to obtain an equivalent particle size for an assumed spherical morphology.

### Example 22

### Production of an Inventive Dispersion with Carbon Nanotubes Having High Specific Surface Area, NMP as Dispersion Medium and Ethyl Cellulose as Dispersing Aid

6 g of carbon nanotubes of the Nanocyl NC 7000 type (NANOCYL S.A, Belgium) having a specific BET surface area of about 250-300 m²/g were ground with a knife mill (Retsch, Grindomix GM300) for 60 min. 2.4 g of ethyl cellulose (EC, ETHOCELL Standard 100, Dow Wolff Cellulosics) were dissolved completely in 191.6 g of NMP while stirring. The ground material was subsequently mixed with the prepared solution and homogenized with a rotor-stator system (Fluid Kotthoff GmbH) for 90 min. Thereafter, the material was dispersed with the batchwise Micron LAB 40 homogenizer (APV Gaulin Deutschland GmbH, Lübeck, Germany) at a pressure of 1000 bar. The dispersing operation was repeated 5 times. In a further experiment, 6 g of carbon nanotubes of the Ube AMC type (UBE Industries, Japan), 1.2 g of ethyl cellulose (EC, ETHOCELL Standard 100, Dow Wolff Cellulosics) were processed together with 192.8 g NMP in an analogous process.

### Analysis Results

FIG. 19 shows the particle size distribution for the dispersions obtained according to example 22. The data were obtained by means of laser diffraction on a Malvern Mastersizer MS2000 Hydro MU system. In FIG. 19, the cumulative volume fraction Q₃ is plotted against the equivalent particle size for the two dispersions (Nanocyl NC7000: solid line; Ube AMC: dotted line). The volume-based fraction of particles having a size of ≦1 μm in the dispersion produced with Nanocyl NC 7000 is about 87%. In the dispersion produced with Ube AMC, it is nearly 100%. In the particle size determination of carbon nanotubes by means of laser diffraction, it has to be taken into account that, because of the narrow, elongated shape of the CNTs, it is only possible to obtain an equivalent particle size for an assumed spherical morphology.

This result shows the universality of the process described in this invention, which is applicable not just to the C70P or C150P grades from Bayer MaterialScience, but also to grades from other manufacturers.

1.-15. (canceled)

16. A dispersion comprising a dispersion medium, a polymeric dispersing aid and carbon nanotubes dispersed in the dispersion medium, wherein the proportion of carbon nanotubes present in agglomerates having an average agglomerate size of ≧1 μm in the total amount of carbon nanotubes is ≦40% by volume, and in that ≧70% by weight of the carbon nanotubes present in nonagglomerated form have a length of ≧200 nm.

17. The dispersion as claimed in claim 16, wherein the dispersion medium is selected from the group consisting of water, acetone, nitriles, alcohols, dimethylformamide (DMF), N-methylpyrrolidone (NMP), pyrrolidone derivatives, butyl acetate, methoxypropyl acetate, alkylbenzenes, cyclohexane derivatives and mixtures thereof.

18. The dispersion as claimed in claim 16, wherein the dispersing aid is selected from the group consisting of poly(vinylpyrrolidone) (PVP), polyvinylpyridines, polystyrene (PS), poly(4-vinylpyridine-co-styrene), poly(styrenesulfonate) (PSS), lignosulfonic acid, lignosulfonate, poly(phenylacetylene) (PPA), poly(meta-phenylenevinylene) (PmPV), polypyrrole (PPy), poly(p-phenylenebenzobisoxazole) (PBO), naturally occurring polymers, anionic aliphatic surfactants, poly(vinyl alcohol) (PVA), polyoxyethylene surfactants, poly(vinylidene fluoride) (PVdF), cellulose derivatives, mixtures of different cellulose derivatives, polyvinyl chloride (PVC), polysaccharides, styrene-butadiene rubber (SBR), polyamides, polyimides, block copolymers and mixtures thereof.

19. The dispersion as claimed in claim 18, wherein the dispersing aid is selected from the group consisting of poly(vinylpyrrolidone) (PVP), poly(4-vinylpyridine), poly(2-vinylpyridine), polystyrene (PS), poly(4-vinylpyridine-co-styrene), poly(styrenesulfonate) (PSS), lignosulfonic acid, lignosulfonate, poly(phenylacetylene) (PPA), poly(meta-phenylenevinylene) (PmPV), polypyrrole (PPy), poly(p-phenylenebenzobisoxazole) (PBO), naturally occurring polymers, anionic aliphatic surfactants, poly(vinyl alcohol) (PVA), polyoxyethylene surfactants, poly(vinylidene fluoride) (PVdF), cellulose derivatives, mixtures of different cellulose derivatives, polyvinyl chloride (PVC), polysaccharides, styrene-butadiene rubber (SBR), polyamides, polyimides, acrylic block copolymers, ethylene oxide-propylene oxide copolymers and mixtures thereof.

20. The dispersion as claimed in claim 16, wherein the dispersing aid comprises lithium ions.

21. The dispersion as claimed in claim 16, wherein the ratio of the concentration of the dispersing aid in the dispersion medium and the concentration of the carbon nanotubes in the dispersion medium is within a range from ≧0.01:1 to ≦10:1.

22. The dispersion as claimed in claim 16, wherein dispersion further comprises conductive carbon black, graphite and/or graphene.

23. A process for producing the dispersion as claimed in claim 16, which comprises dispersing a precursor dispersion comprising a dispersion medium, a polymeric dispersing aid and carbon nanotubes by means of a high-pressure homogenizer.

24. The process as claimed in claim 23, wherein the dispersion by means of the high-pressure homogenizer is conducted more than once.

25. The process as claimed in claim 23, wherein the high-pressure homogenizer is a jet disperser and has at least one nozzle having a bore diameter of ≧0.05 to ≦1 mm and a length to diameter ratio of the bore of ≧1 to ≦10, wherein there is a pressure differential of ≧5 bar between the nozzle inlet and nozzle outlet.

26. The process as claimed in claim 25, wherein the jet disperser has at least one slot having a slot width of ≧0.05 to ≦1 mm and a depth to slot width ratio of the slot of ≧1 to ≦10, wherein there is a pressure differential of ≧5 bar between the nozzle inlet and nozzle outlet.

27. A composition for production of an electrode, comprising the dispersion as claimed in claim 16, an electrode material and a polymeric binder, wherein the binder is present in the composition at least partly in dissolved form.

28. The composition as claimed in claim 27, wherein the electrode material is selected from the group of LiNiₓMn_{y}Al_{z}Co_{1-x-y-z}O₂ (0≦x, y, z≦1 and x+y+z≦1), LiNi_{0.33}Mn_{0.33}Co_{0.33}O₂, LiCoO₂, LiNi_{0.7}Co_{0.3}O₂, LiNi_{0.8}Co_{0.2}O₂, LiNi_{0.9}Co_{0.1}O₂, LiNiO₂, LiMn₂O₄, LiMn_{1.5}(Co,Fe,Cr)_{0.5}O₄, LiNiₓAl_{y}Co_{1-x-y}O₂ (0≦x, y≦1 and x+y≦1), LiNi_{0.8}Co_{0.15}Al_{0.05}O₂, LiNi_{0.78}Co_{0.19}Al_{0.03}O₂, LiNi_{0.78}Co_{0.19}Al_{0.03}MₓO₂ (x=0.0001-0.05, M=alkali metals or alkaline earth metals), LiFePO₄, Li₂FeP₂O₇, LiCoPO₄, Li₁₊ₓM_{y}Mn_{2-x-y}O₄ (M=Al, Cr, Ga), LiTiS₂, Li₂V₂O₅, LiV₃O₈, Li₂TiS₃, Li₃NbSe₃, Li₂TiO₃, sulfur, polysulfides and/or sulfur-containing materials.

29. The composition as claimed in claim 27, wherein the electrode material is a natural or synthetic graphite, hard carbon having a stable unordered structure composed of very small and thin carbon platelets crosslinked with one another, soft graphitic carbon, silicon, silicon alloys, silicon-containing mixtures, lithium titanate (Li₂TiO₃ or Li₄Ti₅O₁₂), tin alloys, Co₃O₄, Li_{2.6}Co_{0.4}N and/or tin oxide (SnO₂).

30. A process for producing an electrode, comprising the steps of:
providing the composition as claimed in claim 27;
applying the composition to an output conductor;
at least partly removing liquid substances from the mixture applied beforehand.

31. An electrochemical element comprising an electrode produced according to claim 30.
